(19) United States
(12) Patent Application Publication
(10) Pub. No.: US 2023/0042842 A1
(43) Pub. Date: Feb. 9, 2023

(54) NEGOTIATION METHOD FOR AN OPERATING MODE, INITIATOR, RECEIVER, CHIP SYSTEM, AND MEDIUM

(71) Applicant: HUAWEI TECHNOLOGIES CO., LTD., Shenzhen (CN)

(72) Inventors: Jian YU, Shenzhen (CN); Yunbo LI, Shenzhen (CN); Yuchen GUO, Shenzhen (CN); Ming GAN, Shenzhen (CN); Mengshi HU, Shenzhen (CN)

(21) Appl. No.: 17/960,168

(22) Filed: Oct. 5, 2022

Related U.S. Application Data
(63) Continuation of application No. PCT/CN2021/077313, filed on Feb. 22, 2021.

(30) Foreign Application Priority Data
Apr. 10, 2020 (CN) 202010281486.6

(51) Int. Cl. H04L 5/00

(52) U.S. Cl. CPC H04L 5/0098; H04L 5/0023; H04W 84/12

(57) ABSTRACT

A negotiation method for an operating mode, an initiator, a receiver, a chip system, a computer-readable storage medium, and a functional entity are disclosed. In operating mode (OM) negotiation, the initiator transmits an operating mode indication (OMI) to the responder. The OMI includes at least either of channel width indication information and space-time stream number indication information. A capability range of a channel width indicated by the channel width indication information is greater than 160 MHz. A capability range of the number of space-time streams indicated by the space-time stream number indication information is greater than 8. After receiving the OMI, the responder performs transmission with the initiator based on a negotiated OM.

### CROSS-REFERENCE TO RELATED APPLICATIONS

This application is a continuation of International Application No. PCT/CN2021/077313, filed on Feb. 22, 2021, which claims priority to Chinese Patent Application No. 202010281486.6, filed on Apr. 10, 2020. The disclosures of the aforementioned applications are hereby incorporated in entirety by reference.

### BACKGROUND

A WLAN (Wireless Local Area Network, wireless local area network) develops from 802.11a/g, to 802.11n, 802.11ac, and 802.11ax. A channel width and the number of space-time streams that are allowed to be transmitted by the WLAN are as follows:

TABLE 1
Maximum channel width and maximum number of space-time streams allowed to be transmitted

| | | | | 802.11ac | 802.11ax | 802.11be |
|---|---|---|---|---|---|---|
| | 802.11a/g | | 802.11n(HT) | (VHT) | (HE) | (EHT) |
| Channel width | 20 | MHz | 20 MHz and | 20 MHz, 40 MHz, | 20 MHz, 40 MHz, | 20 MHz, 40 MHz, 80 MHz, |
| | | | 40 MHz | 80 MHz, and | 80 MHz, and | 160 MHz, 240 MHz, and |
| | | | | 160 MHz | 160 MHz | 320 MHz |
| Number of space- | 1 | | 1 to 4 | 1 to 8 | 1 to 8 | 1 to 16 |
| time streams/number | | | | | | |
| of spatial streams | | | | | | |
| Supported maximum | 54 | Mbit/s | 600 Mbit/s | 6.9 Gbit/s | 9.6 Gbit/s | 46.08 Gbit/s |
| data rate (data rate) | | | | | | |

The 802.11n standard is also called high throughput (High Throughput, HT), the 802.11ac standard is called very high throughput (Very High Throughput, VHT), and the 802.11ax standard is called high efficient (High Efficient, HE). Standards prior to HT, such as 802.11a/b/g, are collectively referred to as Non-HT (non-high throughput). In addition, the 802.11 series standards further include 802.11b that uses a non-OFDM (Orthogonal Frequency Division Multiplexing, orthogonal frequency division multiplexing) mode.

As a channel width increases, the number of MIMO (Multiple Input Multiple Output, multiple-input multiple-output) space-time streams increases, and a data rate for data transmission also increases (as shown in the Table 1). However, more power is consumed. A greater channel width means that a channel width of a radio frequency front end needs to be greater, there are a greater number of streams, and more radio frequency links are called for. In addition, more data needs to be processed per unit time. Therefore, total power consumption increases accordingly.

An operating mode indication (Operation Mode Indication, OMI) method is designed in the 802.11ax standard. An initiator and a responder negotiate an operating mode (Operation Mode, OM). A normal operating channel width and a normal number of space-time streams are reduced to cut power consumption. When a large amount of service traffic needs to be transmitted, a greater channel width and a greater number of space-time streams are restored.

In a next-generation standard after the 802.11ax, for example, the 802.11be standard, also referred to as an extremely high throughput (Extremely High Throughput, EHT) standard, there are more channel width modes, and the number of space-time streams is expanded from a maximum of 8 to a maximum of 16. How to negotiate an enhanced OMI for the 802.11be standard is an urgent technical problem to be resolved.

### SUMMARY

In some embodiments, a negotiation method for an operating mode, applied to an initiator and a receiver for operating mode negotiation, a chip system, and a computer-readable storage medium is provided. In this case, OM negotiation is implemented in a scenario in which channel width modes increase and the number of space-time streams exponentially increases.

In some embodiments, an OM negotiation solution in an existing 802.11ax standard is extended, and a new OM negotiation solution is provided, to implement enhanced OM negotiation.

Some embodiments disclose a negotiation method for an operating mode, applied to an initiator for operating mode negotiation. The method includes the following steps.

An initiator transmits an operating mode indication OMI to a responder. The OMI includes at least either of channel width indication information and space-time stream number indication information. A capability range of a channel width indicated by the channel width indication information is greater than 160 MHz. A capability range of the number of space-time streams indicated by the space-time stream number indication information is greater than 8.

Alternatively, a capability range of a channel width indicated by the channel width indication information is less than or equal to 160 MHz. A capability range of the number of space-time streams indicated by the space-time stream number indication information is greater than 8.

Alternatively, a capability range of a channel width indicated by the channel width indication information is greater than 160 MHz. A capability range of the number of space-time streams indicated by the space-time stream number indication information is smaller than or equal to 8.

The initiator performs transmission with the responder. The initiator performs transmission with the responder by using at least either of a channel width not exceeding the channel width indicated by the OMI and the number of space-time streams not exceeding the number of space-time streams that is indicated by the OMI.

In some embodiments, there is a plurality of combination relationships between the channel width range indicated by the channel width indication information and the range of the number of space-time streams indicated by the space-time stream number indication information. For example:

The channel width range indicated by the channel width indication information is greater than 160 MHz. The range of the number of space-time streams indicated by the space-time stream number indication information is 1 to 8 (that the number of space-time streams is 1 to 8 is indicated by enhanced space-time stream number indication information in some embodiments, or space-time stream number indication information in the 802.11ax standard and a previous standard).

Alternatively, the channel width range indicated by the channel width indication information is greater than or equal to 20 MHz and less than or equal to 160 MHz (that the channel width range is less than or equal to 160 MHz is indicated by enhanced channel width indication information in some embodiments, or channel width indication information in the 802.11ax standard and a previous standard). The range of the number of space-time streams indicated by the space-time stream number indication information is 1 to 16.

Alternatively, the channel width range indicated by the channel width indication information is greater than or equal to 20 MHz and less than or equal to 160 MHz (that the channel width range is less than or equal to 160 MHz is indicated by enhanced channel width indication information in some embodiments, or channel width indication information in the 802.11ax standard and a previous standard). The range of the number of space-time streams indicated by the space-time stream number indication information is 1 to 8 (that the number of space-time streams is 1 to 8 is indicated by enhanced space-time stream number indication information in some embodiments, or space-time stream number indication information in the 802.11ax standard and a previous standard).

Alternatively, the channel width range indicated by the channel width indication information is greater than 160 MHz. The range of the number of space-time streams indicated by the space-time stream number indication information is 1 to 16.

This is an example, and there are other combinations. Details are not described herein again.

The OMI is carried in control information corresponding to a control subfield, and the control information includes at least either of the channel width indication information and the space-time stream number indication information.

In some embodiments, the capability range of the channel width indicated by the channel width indication information is a range of a maximum value of the channel width that is indicated by the channel width indication information, but an actual channel width indicated by the channel width indication information is less than the capability range of the channel width.

For example, the actual channel width indicated by the channel width indication information is any one of 20 MHz, 40 MHz, 80 MHz, 160 MHz, 240 MHz, or 320 MHz, and the maximum value of the channel width is 320 MHz. In some embodiments, the capability range of the channel width indicated by the channel width indication information is greater than 160 MHz.

In some embodiments, the channel width is contiguous, or noncontiguous. For example, 320 MHz is 160 MHz+160 MHz. 240 MHz is 80 MHz+160 MHz or 160 MHz+80 MHz.

In some embodiments, with development of technologies, the capability range of the channel width that is indicated by the channel width indication information provided in some embodiments alternatively is greater than 320 MHz, for example, 480 MHz, 640 MHz, 800 MHz, 960 MHz, 1120 MHz or 1280 MHz.

Likewise, the capability range of the number of space-time streams indicated by the space-time stream number indication information is a range of a maximum value of the number of space-time streams that is indicated by the space-time stream number indication information, but an actual number of space-time streams indicated by the space-time stream number indication information is less than the capability range of the number of space-time streams.

For example, the actual number of space-time streams indicated by the space-time stream number indication information is any one of 1, 2, 3, 4, 5, 6, 7, 8, 9, 10, 11, 12, 13, 14, 15, or 16, and the maximum value of the number of space-time streams is 16. In some embodiments, the capability range of the number of space-time streams indicated by the space-time stream number indication information is greater than 8.

With development of technologies, the capability range of the space-time stream number indication information that is indicated by the space-time stream number indication information provided in some embodiments alternatively is greater than 16, for example, 20, 24, 32, 48, or 64.

The number of space-time streams in some embodiments further is replaced with the number of spatial streams.

In some embodiments, in the 802.11ax standard, when space-time stream block coding (space-time block coding, STBC) is used, the number of space-time streams is twice the number of spatial streams. When the space-time stream block coding is not used, the two numbers are the same.

In some embodiments, the space-time stream number indication information indicates the number of spatial streams, or the number of space-time streams, or partially indicate the number of space-time streams, and partially indicate the number of spatial streams.

For example, for a transmitter, the space-time stream number indication information indicates the number of transmitted space-time streams. For a receiver, the space-time stream number indication information indicates the number of received spatial streams. Alternatively, for the transmitter, the space-time stream number indication information indicates the number of received spatial streams. For the receiver, the space-time stream number indication information indicates the number of transmitted space-time streams. The space-time stream number indication information includes at least either of indication information of the number of transmitted space-time streams and indication information of the number of received space-time streams.

The space-time stream number indication information indicates both the number of transmitted space-time streams and the number of received space-time streams.

The initiator and the responder in some embodiments are described from the perspective of an OM negotiation process. One that actively initiates OM negotiation is referred to as the initiator, and one that responds to the OM negotiation is referred to as the responder. The transmitter and the receiver are described from the perspective of a communications transmission process. A party that transmits data is the transmitter, and a party that receives the data is the receiver. The initiator for the OM negotiation is the transmitter or the receiver for communications transmission. The responder for the OM negotiation is the transmitter or the responder for communications transmission.

The foregoing descriptions are applicable to various designs and implementations of various aspects of the embodiments. Details are not described subsequently.

In some embodiments, the control subfield includes a first control subfield and a second control subfield.

The first control subfield is an OMI basic indication subfield, in other words, the first control subfield is a control subfield indicating OMI in the 802.11ax standard. The second control subfield is an OMI extension indication subfield, in other words, the second control subfield is a control subfield that is different from the control subfield indicating OMI in the 802.11ax standard. The first control subfield and the second control subfield jointly indicate an enhanced OMI.

In some embodiments, in comparison with a range that is indicated by the OMI in the 802.11ax standard, the enhanced OMI indicates a channel width in a greater range and more space-time streams.

In some embodiments, a value of a control identifier corresponding to the first control subfield is 1, and a value of a control identifier corresponding to the second control subfield is any one of 7 to 15.

In some embodiments, the number of bits of first channel width indication information that is in control information corresponding to the first control subfield and that indicates a channel width is 2. The number of bits of second channel width indication information that is in control information corresponding to the second control subfield and that indicates a channel width is 1. A channel width range jointly indicated by the first channel width indication information and the second channel width indication information is 20 MHz to 320 MHz.

In some embodiments, with development of technologies, the channel width range jointly indicated by the first channel width indication information and the second channel width indication information is greater, for example, 20 MHz to 640 MHz, or even 20 MHz to 1280 MHz. The number of bits of the second channel width indication information remains 1, or increase to 2, 3, or the like accordingly.

In some embodiments, a bit of the second channel width indication information is a least significant bit or a most significant bit in 3 bits formed by 2 bits of the first channel width indication information and 1 bit of the second channel width indication information.

In some embodiments, the number of bits of first space-time stream number indication information that is in control information corresponding to the first control subfield and that indicates the number of space-time streams is 3. The number of bits of second space-time stream number indication information that is in control information corresponding to the second control subfield and that indicates the number of space-time streams is 1. A range of the number of space-time streams jointly indicated by the first space-time stream number indication information and the second space-time stream number indication information is 1 to 16.

In some embodiments, with development of technologies, the range of the number of space-time streams jointly indicated by the first space-time stream number indication information and the second space-time stream number indication information is greater, for example, 1 to 32, or even 1 to 64. The number of bits of the second space-time stream number indication information remains 1, or increase to 2, 3, or the like accordingly.

In some embodiments, 1 bit of the second space-time stream number indication information is a least significant bit or a most significant bit in 3 bits formed by 2 bits of the first space-time stream number indication information and 1 bit of the second space-time stream number indication information.

In some embodiments, the number of space-time streams jointly indicated by the first space-time stream number indication information and the second space-time stream number indication information is less than or equal to the number of space-time streams of a preset channel width value.

The preset channel width value is 80 MHz or 160 MHz.

In some embodiments, when the first channel width indication information and the second channel width indication information jointly indicate different channel widths, the first space-time stream number indication information and the second space-time stream number indication information jointly indicate a same number of space-time streams.

In the two control subfields provided in some embodiments, based on the OMI basic indication subfield, the other control subfield is used as the OMI extension indication subfield. In this case, maximum compatibility with the 802.11ax standard is achieved, and OM negotiation on a greater channel width or more space-time streams is implemented at low overheads.

The foregoing describes how to implement enhanced OM negotiation by using the two control fields. OM negotiation in some embodiments further is implemented by using one control subfield, which is described in the following by using different implementations.

In some embodiments, the control subfield is one control subfield, and is referred to as a third control subfield.

In some embodiments, the OMI is carried in control information corresponding to the third control subfield. The control information includes at least either of third channel width indication information and third space-time stream number indication information.

In some embodiments, the third channel width indication information is 3 bits, and indicates a channel width range from 20 MHz to 320 MHz. The third space-time stream number indication information is 4 bits, and indicates that a range of the number of space-time streams is 1 to 16.

In some embodiments, the third channel width indication information indicates a greater channel width range, for example, indicate 640 MHz. The third space-time stream number indication information indicates a greater range of the number of space-time streams, for example, 1 to 32, or 1 to 64. Correspondingly, the number of bits of the third channel width indication information increases as the width range increases, for example, is 4 or 5. The number of bits of the third space-time stream number indication information further increases as the range of the number of space-time streams increases, for example, is 5 or 6.

In some embodiments, the third control subfield is one control subfield located after a control subfield whose identifier value is 15. An identifier value of the third control subfield is any one of 0 to 15.

Optionally, the number of space-time streams indicated by the third space-time stream number indication information is less than or equal to the number of space-time streams of a preset channel width value.

The preset channel width value is 80 MHz or 160 MHz.

Optionally, when the third channel width indication information indicates different channel widths, the third space-time stream number indication information indicate a same number of space-time streams.

In some embodiments, in the 802.11ax standard, the control subfield whose identifier value is 15 is used as an identifier point indicating the enhanced OMI. In this case, the responder for the OM negotiation is configured to use the identifier point as an identifier, and identify a control subfield following the control subfield whose identifier value is 15 as an enhanced OM control subfield. This supports negotiation on a greater channel width and a greater number of space-time streams.

In some embodiments, the third channel width indication information includes first channel width indication sub-information and second channel width indication sub-information. The first channel width indication sub-information is 2 bits. The second channel width indication sub-information is 1 bit. The first channel width indication sub-information and the second channel width indication sub-information jointly indicate a channel width.

In some embodiments, the third space-time stream number indication information includes first space-time stream number indication sub-information and second space-time stream number indication sub-information. The first space-time stream number indication sub-information is 3 bits. The second space-time stream number indication sub-information is 1 bit. The first space-time stream number indication sub-information and the second space-time stream number indication sub-information jointly indicate the number of space-time streams.

In some embodiments, an identifier value of the third control subfield is any one of 0 to 15. The identifier value corresponding to the third control subfield is 1. Optionally, the third control subfield is one control subfield located after a control subfield whose identifier value is 15.

Optionally, when the first channel width indication information and the second channel width indication information jointly indicate different channel widths, the first space-time stream number indication information and the second space-time stream number indication information jointly indicate a same number of space-time streams.

Optionally, the number of space-time streams jointly indicated by the first space-time stream number indication sub-information and the second space-time stream number indication sub-information is less than or equal to the number of space-time streams of a preset channel width value.

The preset channel width value is 80 MHz or 160 MHz.

In some embodiments, the channel width indication information or the space-time stream number indication information in the control subfield in the 802.11ax standard is carried in two indication subfields. This implements the enhanced OM negotiation while ensuring maximum compatibility with the 802.11ax standard.

In some embodiments, the control subfield is one control subfield, and is referred to as a fourth control subfield.

In some embodiments, the OMI is carried in control information corresponding to the fourth control subfield. The control information includes at least either of fourth channel width indication information and fourth space-time stream number indication information.

Optionally, the fourth channel width indication information is 2 bits, and indicates a channel width range from 20 MHz to 320 MHz. The fourth space-time stream number indication information is 3 bits, and indicates that a range of the number of space-time streams is 1 to 16.

In some embodiments, both the initiator and the responder support a standard after the 802.11ax, and the number of space-time streams indicated by the fourth space-time stream number indication information is any value from 1 to 16. Optionally, the fourth space-time stream number indication information indicates any eight values from 1 to 16.

Alternatively, either of the initiator and the responder does not support a standard after the 802.11ax, and the number of space-time streams indicated by the fourth space-time stream number indication information is any value from 1 to 8.

In some embodiments, both the initiator and the responder support a standard after the 802.11ax, and the channel width range indicated by the fourth channel width indication information is 20 MHz to 320 MHz.

Alternatively, either of the initiator and the responder does not support a standard after the 802.11ax, and a channel width range indicated by the fourth channel width indication information is 20 MHz to 160 MHz.

In some embodiments, the fourth channel width indication information indicates a greater channel width range, for example, indicate 480 MHz, 640 MHz, 800 MHz, 960 MHz, 1120 MHz. The fourth space-time stream number indication information indicates a greater range of the number of space-time streams, for example, 1 to 32, or 1 to 64. The number of space-time streams is 20, 24, 32, 48, 64, or the like.

In some embodiments, the fourth channel width indication information indicates any one of the following four types:

a channel width of 20 MHz, a channel width of 40 MHz, a channel width of 80 MHz, and supported within a capability range.

In some embodiments, the number of space-time streams indicated by the fourth space-time stream number indication information is less than or equal to the number of space-time streams of a preset channel width value.

The preset channel width value is 80 MHz or 160 MHz.

In some embodiments, when the fourth channel width indication information indicates different channel widths, the fourth space-time stream number indication information indicate a same number of space-time streams.

In some embodiments, without increasing the number of bits of an existing control subfield, based on whether a standard after the 802.11ax is supported, same OMI information is parsed into different description. Therefore, the enhanced OM negotiation is implemented while ensuring the maximum compatibility with the 802.11ax standard at minimum overheads.

Some embodiments disclose a negotiation method for an operating mode, applied to a responder for operating mode negotiation. The method includes the following steps.

The responder receives an operating mode indication OMI from an initiator, where the OMI includes at least either of channel width indication information and space-time stream number indication information.

A capability range of a channel width indicated by the channel width indication information is greater than 160 MHz. A capability range of the number of space-time streams indicated by the space-time stream number indication information is greater than 8.

Alternatively, a capability range of a channel width indicated by the channel width indication information is less than or equal to 160 MHz. A capability range of the number of space-time streams indicated by the space-time stream number indication information is greater than 8.

Alternatively, a capability range of a channel width indicated by the channel width indication information is greater than 160 MHz. A capability range of the number of space-time streams indicated by the space-time stream number indication information is smaller than or equal to 8.

The responder performs transmission with the initiator based on the OMI.

The initiator performs transmission with the responder. The responder performs transmission with the initiator by using at least either of a channel width not exceeding a channel width indicated by the OMI and the number of space-time streams not exceeding the number of space-time streams that is indicated by the OMI.

In some embodiments, the control subfield includes a first control subfield and a second control subfield.

The first control subfield is an OMI basic indication subfield, in other words, the first control subfield is a control subfield indicating OMI in an 802.11ax standard. The second control subfield is an OMI extension indication subfield, in other words, the second control subfield is a control subfield that is different from the control subfield indicating OMI in the 802.11ax standard. The first control subfield and the second control subfield jointly indicate an enhanced OMI.

In some embodiments, in comparison with a range that is indicated by the OMI in the 802.11ax standard, the enhanced OMI indicates at least either of a channel width in a greater range and more space-time streams.

In some embodiments, a value of a control identifier corresponding to the first control subfield is 1, and a value of a control identifier corresponding to the second control subfield is any one of 7 to 15.

In some embodiments, the number of bits of first channel width indication information that is in control information corresponding to the first control subfield and that indicates a channel width is 2. The number of bits of second channel width indication information that is in control information corresponding to the second control subfield and that indicates a channel width is 1. A channel width range jointly indicated by the first channel width indication information and the second channel width indication information is 20 MHz to 320 MHz.

The responder jointly parses first channel width indication information and second channel width indication information, to obtain an indicated channel width.

In some embodiments, with development of technologies, the channel width range jointly indicated by the first channel width indication information and the second channel width indication information is greater, for example, 20 MHz to 640 MHz, or even 20 MHz to 1280 MHz. The number of bits of the second channel width indication information remains 1, or increase to 2, 3, or the like accordingly.

In some embodiments, a bit of the second channel width indication information is a least significant bit or a most significant bit in 3 bits formed by 2 bits of the first channel width indication information and 1 bit of the second channel width indication information.

In some embodiments, the number of bits of first space-time stream number indication information that is in the control information corresponding to the first control subfield and that indicates the number of space-time streams is 3. The number of bits of second space-time stream number indication information that is in control information corresponding to the second control subfield and that indicates the number of space-time streams is 1. A range of the number of space-time streams jointly indicated by the first space-time stream number indication information and the second space-time stream number indication information is 1 to 16.

In some embodiments, with development of technologies, the range of the number of space-time streams jointly indicated by the first space-time stream number indication information and the second space-time stream number indication information is greater, for example, 1 to 32, or even 1 to 64. The number of bits of the second space-time stream number indication information remains 1, or increase to 2, 3, or the like accordingly.

The responder jointly parses first space-time stream number indication information and second space-time stream number indication information, to obtain an indicated number of space-time streams.

In some embodiments, 1 bit of the second space-time stream number indication information is a least significant bit or a most significant bit in 3 bits formed by 2 bits of the first space-time stream number indication information and 1 bit of the second space-time stream number indication information.

In some embodiments, the number of space-time streams jointly indicated by the first space-time stream number indication information and the second space-time stream number indication information is less than or equal to the number of space-time streams of a preset channel width value.

The preset channel width value is 80 MHz or 160 MHz.

In some embodiments, when the first channel width indication information and the second channel width indication information jointly indicate different channel widths, the first space-time stream number indication information and the second space-time stream number indication information jointly indicate a same number of space-time streams.

In the two control subfields provided in some embodiments, based on the OMI basic indication subfield, the other control subfield is used as the OMI extension indication subfield. In this case, maximum compatibility with the 802.11ax standard is achieved, and OM negotiation on a greater channel width or more space-time streams is implemented at low overheads.

The foregoing describes how to implement enhanced OM negotiation by using the two control fields. OM negotiation in some embodiments further is implemented by using one control subfield, which is described in the following by using different implementations.

In some embodiments, the control subfield is one control subfield, and is referred to as a third control subfield.

In some embodiments, the OMI is carried in control information corresponding to the third control subfield. The control information includes at least either of third channel width indication information and third space-time stream number indication information.

In some embodiments, the third channel width indication information is 3 bits, and indicates a channel width range from 20 MHz to 320 MHz. The third space-time stream number indication information is 4 bits, and indicates that a range of the number of space-time streams is 1 to 16.

In some embodiments, the third channel width indication information indicates a greater channel width range, for example, indicate 640 MHz. The third space-time stream number indication information indicates a greater range of the number of space-time streams, for example, 1 to 32, or 1 to 64. Correspondingly, the number of bits of the third channel width indication information increases as the width range increases, for example, is 4 or 5. The number of bits of the third space-time stream number indication information further increases as the range of the number of space-time streams increases, for example, is 5 or 6.

In some embodiments, the third control subfield is one control subfield located after a control subfield whose identifier value is 15. The identifier value of the third control subfield is any one of 0 to 15.

Optionally, the number of space-time streams indicated by the third space-time stream number indication information is less than or equal to the number of space-time streams of a preset channel width value.

The preset channel width value is 80 MHz or 160 MHz.

Optionally, when the third channel width indication information indicates different channel widths, the third space-time stream number indication information indicate a same number of space-time streams.

In some embodiments, in the 802.11ax standard, the control subfield whose identifier value is 15 is used as an identifier point indicating the enhanced OMI. In this case, the responder for the OM negotiation is configured to use the identifier point as an identifier, and identify a control subfield following the control subfield whose identifier value is 15 as an enhanced OM control subfield. This supports negotiation on a greater channel width and a greater number of space-time streams.

In some embodiments, the third channel width indication information includes first channel width indication sub-information and second channel width indication sub-information. The first channel width indication sub-information is 2 bits. The second channel width indication sub-information is 1 bit. The first channel width indication sub-information and the second channel width indication sub-information jointly indicate a channel width.

The responder jointly parses first channel width indication sub-information and second channel width indication sub-information, to obtain an indicated channel width.

In some embodiments, the third space-time stream number indication information includes first space-time stream number indication sub-information and second space-time stream number indication sub-information. The first space-time stream number indication sub-information is 3 bits. The second space-time stream number indication sub-information is 1 bit. The first space-time stream number indication sub-information and the second space-time stream number indication sub-information jointly indicate the number of space-time streams.

The responder jointly parses the first space-time stream number indication sub-information and the second space-time stream number indication sub-information, to obtain an indicated number of space-time streams.

In some embodiments, an identifier value of the third control subfield is any one of 0 to 15. The identifier value corresponding to the third control subfield is 1. Optionally, the third control subfield is one control subfield located after a control subfield whose identifier value is 15.

Optionally, when the first channel width indication information and the second channel width indication information jointly indicate different channel widths, the first space-time stream number indication information and the second space-time stream number indication information jointly indicate a same number of space-time streams.

Optionally, the number of space-time streams jointly indicated by the first space-time stream number indication sub-information and the second space-time stream number indication sub-information is less than or equal to the number of space-time streams of a preset channel width value.

The preset channel width value is 80 MHz or 160 MHz.

In some embodiments, the channel width indication information or the space-time stream number indication information in the control subfield in the 802.11ax standard is carried in two indication subfields. This implements the enhanced OM negotiation while ensuring maximum compatibility with the 802.11ax standard.

In some embodiments, the control subfield is one control subfield, and is referred to as a fourth control subfield.

In some embodiments, the OMI is carried in control information corresponding to the fourth control subfield. The control information includes at least either of fourth channel width indication information and fourth space-time stream number indication information.

Optionally, the fourth channel width indication information is 2 bits, and indicates a channel width range from 20 MHz to 320 MHz. The fourth space-time stream number indication information is 3 bits, and indicates that a range of the number of space-time streams is 1 to 16.

In some embodiments, the responder supports a standard after the 802.11ax, and the number of space-time streams indicated by the fourth space-time stream number indication information is any value from 1 to 16. Optionally, the fourth space-time stream number indication information indicates any eight values from 1 to 16.

Alternatively, the responder does not support a standard after the 802.11ax, and the number of space-time streams indicated by the fourth space-time stream number indication information is any value from 1 to 8.

In some embodiments, the responder supports a standard after the 802.11ax, and the channel width range indicated by the fourth channel width indication information is 20 MHz to 320 MHz.

Alternatively, the responder does not support a standard after the 802.11ax, and a channel width range indicated by the fourth channel width indication information is 20 MHz to 160 MHz.

In some embodiments, the fourth channel width indication information indicates a greater channel width range, for example, indicate 480 MHz, 640 MHz, 800 MHz, 960 MHz, 1120 MHz. The fourth space-time stream number indication information indicates a greater range of the number of space-time streams, for example, 1 to 32, or 1 to 64. The number of space-time streams is 20, 24, 32, 48, 64, or the like.

In some embodiments, the fourth channel width indication information indicates any one of the following four types:

a channel width of 20 MHz, a channel width of 40 MHz, a channel width of 80 MHz, and supported within a capability range.

In some embodiments, the number of space-time streams indicated by the fourth space-time stream number indication information is less than or equal to the number of space-time streams of a preset channel width value.

The preset channel width value is 80 MHz or 160 MHz.

In some embodiments, when the fourth channel width indication information indicates different channel widths, the fourth space-time stream number indication information indicate a same number of space-time streams.

In some embodiments, without increasing the number of bits of an existing control subfield, based on whether a standard after the 802.11ax is supported, same OMI information is parsed into different description. Therefore, the enhanced OM negotiation is implemented while ensuring the maximum compatibility with the 802.11ax standard at minimum overheads.

In some embodiments, a communications apparatus is provided. As an initiator for operating mode negotiation, the communications apparatus has some or all functions of implementing the method examples. For example, functions of the communications apparatus is configured to have some or all functions of the embodiments, or is configured to have a function of independently implementing any embodiment. The functions are implemented by hardware, or are implemented by hardware by executing corresponding software. The hardware or the software includes one or more units or modules corresponding to the functions.

In some embodiments, a structure of the communications apparatus includes a processing unit and a communications unit. The processing unit is configured to support the initiator to perform a corresponding function in the foregoing method. The communications unit is configured to support communications between the initiator and another device. The initiator further includes a storage unit. The storage unit is configured to be coupled to the processing unit and a sending unit, and the storage unit stores program instructions and data that are for the communications apparatus.

In an implementation, the communications apparatus includes:

a communications unit, configured to send an operating mode indication OMI to a responder. The OMI includes at least either of channel width indication information and space-time stream number indication information.

A capability range of a channel width indicated by the channel width indication information is greater than 160 MHz. A capability range of the number of space-time streams indicated by the space-time stream number indication information is greater than 8.

Alternatively, a capability range of a channel width indicated by the channel width indication information is less than or equal to 160 MHz. A capability range of the number of space-time streams indicated by the space-time stream number indication information is greater than 8.

Alternatively, a capability range of a channel width indicated by the channel width indication information is greater than 160 MHz. A capability range of the number of space-time streams indicated by the space-time stream number indication information is smaller than or equal to 8.

Optionally, the communications apparatus further includes a processing unit, configured to perform transmission with the responder.

For example, the processing unit is a processor, the communications unit is a transceiver or a communications interface, and the storage unit is a memory.

In an implementation, the communications apparatus includes:

a transceiver, configured to send an operating mode indication OMI to a responder. The OMI includes at least either of channel width indication information and space-time stream number indication information.

A capability range of a channel width indicated by the channel width indication information is greater than 160 MHz. A capability range of the number of space-time streams indicated by the space-time stream number indication information is greater than 8.

Alternatively, a capability range of a channel width indicated by the channel width indication information is less than or equal to 160 MHz. A capability range of the number of space-time streams indicated by the space-time stream number indication information is greater than 8.

Alternatively, a capability range of a channel width indicated by the channel width indication information is greater than 160 MHz. A capability range of the number of space-time streams indicated by the space-time stream number indication information is smaller than or equal to 8.

Optionally, the communications apparatus further includes a processor, configured to perform transmission with the responder.

In some embodiments, a communications apparatus is provided. As a responder for operating mode negotiation, the communications apparatus has some or all functions of implementing the method examples. For example, functions of the communications apparatus is configured to have some or all functions of the embodiments, or is configured to have a function of independently implementing any embodiment. The functions are implemented by hardware, or are implemented by hardware by executing corresponding software. The hardware or the software includes one or more units or modules corresponding to the functions.

In some embodiments, a structure of the communications apparatus includes a processing unit and a communications unit. The processing unit is configured to support the initiator to perform a corresponding function in the foregoing method. The communications unit is configured to support communications between the initiator and another device. The initiator further includes a storage unit. The storage unit is configured to be coupled to the processing unit and a sending unit, and the storage unit stores program instructions and data that are for the communications apparatus.

In an implementation, the communications apparatus includes:

a communications unit, configured to receive an operating mode indication OMI from an initiator, where the OMI includes at least either of channel width indication information and space-time stream number indication information, a capability range of a channel width indicated by the channel width indication information is greater than 160 MHz, and a capability range of the number of space-time streams indicated by the space-time stream number indication information is greater than 8; and

optionally, the communications apparatus further includes a processing unit, configured to perform transmission with the initiator based on the OMI.

For example, the processing unit is a processor, the communications unit is a transceiver or a communications interface, and the storage unit is a memory.

In an implementation, the communications apparatus includes:

a transceiver, configured to receive an operating mode indication OMI from an initiator. The OMI includes at least either of channel width indication information and space-time stream number indication information. A capability range of a channel width indicated by the channel width indication information is greater than 160 MHz. A capability range of the number of space-time streams indicated by the space-time stream number indication information is greater than 8.

Optionally, the communications apparatus further includes a processor, configured to perform transmission with the initiator based on the OMI.

The communications apparatus in some embodiments serves as the initiator and the responder for OM negotiation. From the perspective of an OM negotiation process, one that actively initiates OM negotiation is referred to as the initiator, and one that responds to the OM negotiation is referred to as the responder. The transmitter and the receiver are described from the perspective of a transmission process. A party that transmits data is the transmitter, and a party that receives the data is the receiver. The initiator for the OM negotiation is the transmitter or the receiver for communications transmission. The responder for the OM negotiation is the transmitter or the responder for communications transmission.

The communications apparatus in some embodiments is an access point (access point, AP) station, or a non-access point (non-access point station, non-AP STA) station.

An access point or a station in some embodiments is a multi-link device (multi-link device, MLD).

In an implementation process of the communications apparatuses provided some embodiments, the processor is configured to perform, for example, but not limited to, baseband-related processing, and the transceiver is configured to perform, for example, but not limited to, radio frequency transmission. The foregoing components are separately disposed on chips that are independent of each other, or at least a part or all of the components are disposed on a same chip. For example, the processor further is divided into an analog baseband processor and a digital baseband processor. The analog baseband processor and the transceiver is integrated on a same chip, and the digital baseband processor is disposed on an independent chip. With continuous development of integrated circuit technologies, more components are integrated on a same chip. For example, the digital baseband processor and a plurality of application processors (for example, but not limited to, a graphics processor and a multimedia processor) are integrated on a same chip. The chip is referred to as a system on chip (system on chip). Whether the components are separately disposed on different chips or integrated and disposed on one or more chips usually depends on a product design.

An implementation form of the foregoing components is not limited in the embodiments.

A processor is configured to perform the method in some embodiments. In a process of performing these methods, a process of sending the foregoing information and a process of receiving the foregoing information in the foregoing methods are understood as a process of outputting the foregoing information by the processor and a process of receiving the foregoing input information by the processor. When outputting the information, the processor outputs the information to a transceiver, so that the transceiver transmits the information. Still further, after the information is output by the processor, other processing is further called for to be performed on the information before the information arrives at the transceiver. Similarly, when the processor receives the input information, the transceiver receives the information and inputs the information into the processor. Still further, after the transceiver receives the information, other processing is called for to be performed on the information before the information is input into the processor.

Based on the foregoing principle, for example, the receiving the OMI mentioned in the foregoing method is understood as inputting the OMI by the processor. For another example, transmitting the OMI is understood as outputting the OMI by the processor.

In this case, for operations such as transmission, sending, and receiving related to the processor, if there is no particular statement, or if the operations do not contradict an actual function or internal logic of the operations in related descriptions, the operations are more generally understood as operations such as output, receiving, and input of the processor, instead of operations such as transmission, sending, and receiving directly performed by a radio frequency circuit and an antenna.

In an implementation process, the processor is a processor specially configured to perform these methods, or a processor, for example, a general-purpose processor, that executes computer instructions in a memory to perform these methods. The memory is a non-transitory (non-transitory) memory such as a read-only memory (read only memory, ROM). The memory and the processor is integrated on a same chip, or is separately disposed on different chips. A type of the memory and a manner of disposing the memory and the processor are not limited in the embodiments.

In some embodiments, a computer-readable storage medium, configured to store a computer program used by the foregoing communications apparatus, including a computer program used to perform the foregoing method.

In some embodiments, a computer program product including a computer program is provided. When the computer program product runs on a computer, the computer is enabled to perform the method of some embodiments.

In some embodiments, a chip system is provided. The chip system includes a processor and an interface, configured to support a communications transmission device in implementing a function in some embodiments, for example, determining or processing at least either of data and information in the foregoing method. In a possible design, the chip system further includes a memory, and the memory is configured to store information and data that are for the foregoing communications apparatus. The chip system includes a chip, or includes a chip and another discrete component.

In some embodiments, a functional entity is provided. The functional entity is configured to implement the method according to some embodiments.

### BRIEF DESCRIPTION OF DRAWINGS

FIG. 1 is a schematic diagram of a structure of a network system according to some embodiments;

FIG. 2 is a schematic diagram of a structure of a communications apparatus according to some embodiments;

FIG. 3 is a schematic diagram of a structure of a chip system according to some embodiments;

FIG. 4 is a schematic diagram of a structure of a MAC frame according to some embodiments;

FIG. 5 is a schematic diagram of a structure of an A-control field in an 802.11ax standard according to some embodiments;

FIG. 6 is a schematic diagram of a structure of a control subfield in an 802.11ax standard according to some embodiments;

FIG. 7 is a schematic diagram of a structure of a control subfield according to some embodiments;

FIG. 8 is a schematic diagram of a structure of another control subfield according to some embodiments;

FIG. 9 is a schematic diagram of a structure of still another control subfield according to some embodiments;

FIG. 10 is a schematic diagram of a structure of still another control subfield according to some embodiments; and

FIG. 11 is a schematic diagram of a structure of still another control subfield according to some embodiments.

### DESCRIPTION OF EMBODIMENTS

The following further describes the embodiments in detail with reference to accompanying drawings.

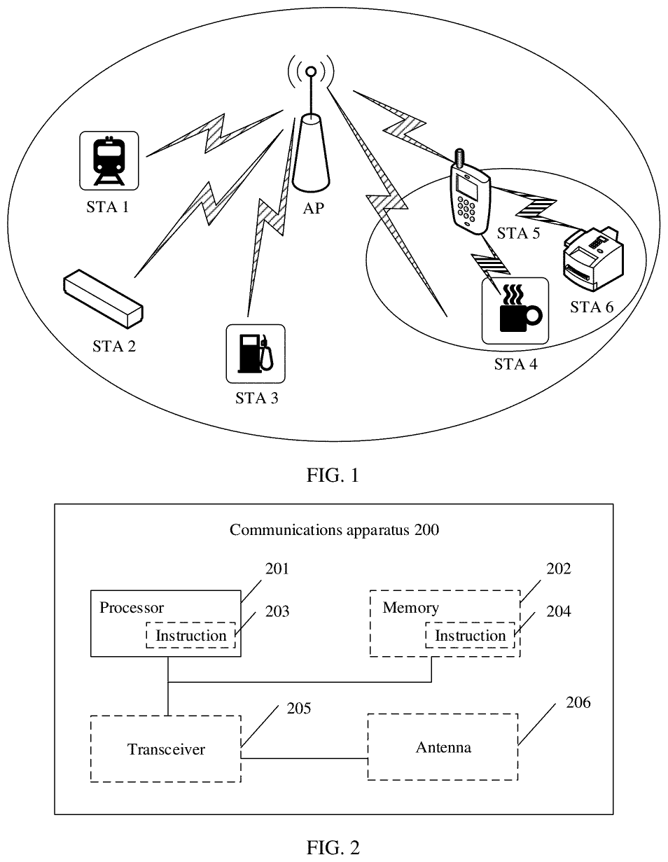

FIG. 1 is used as an example to describe a network structure to which the OM negotiation method in some embodiments is applicable.

FIG. 1 is a schematic diagram of a network structure according to some embodiments. The network structure includes one or more access points (access point, AP) stations and one or more non-access-point stations (non-access point station, non-AP STA). For ease of description, an access point station is referred to as an access point (AP), and a non-access point station is referred to as a station (STA) in this specification.

In some embodiments, both the AP and the STA serves as an initiator and a responder for OM negotiation. The initiator and the responder for the OM negotiation are described from the perspective of an OM negotiation process. One that actively initiates OM negotiation is referred to as the initiator, and one that responds to the OM negotiation is referred to as the responder. A transmitter and a receiver are described from the perspective of a transmission process. A party that transmits data is the transmitter, and a party that receives the data is the receiver. The initiator for the OM negotiation is the transmitter or the receiver for communications transmission. The responder for the OM negotiation is the transmitter or the responder for communications transmission.

The network structure including one AP and six stations (a STA 1, a STA 2, a STA 3, a STA 4, a STA 5, and a STA 6) in FIG. 1 is used as an example for description.

For example, in the OM negotiation process, the AP serves as the initiator for the OM negotiation, and the STA 1 or the STA 2 serves as the responder for the OM negotiation.

Alternatively, the AP serves as the initiator for the OM negotiation, and another AP serves as the responder for the OM negotiation.

Alternatively, the STA 1 serves as the initiator for the OM negotiation, and the STA 2 serves as the responder for the OM negotiation.

In the communications transmission process, both the initiator and the responder for OM negotiation is used as transmitters or receivers for communications transmission. This is not limited.

In some embodiments, the access point is an access point for a terminal device (such as a mobile phone) to access a wired (or wireless) network, and is mainly deployed in a home, a building, and a park. A typical coverage radius is tens of meters to hundreds of meters. Certainly, the network device alternatively is deployed outdoors. The access point is equivalent to a bridge that connects the wired network and the wireless network. A main function of the access point is to connect various wireless network clients together and then connect the wireless network to the Ethernet. The access point is a terminal device (such as a mobile phone) or a network device (such as a router) with a wireless fidelity (wireless fidelity, Wi-Fi) chip. The access point is a device that supports the 802.11be standard. Alternatively, the access point is a device that supports a plurality of wireless local area network (wireless local area network, WLAN) standards of the 802.11 family such as the 802.11be standard, the 802.11ax standard, the 802.11ac standard, the 802.11n standard, the 802.11g standard, the 802.11b standard, and the 802.11a standard. The access point in some embodiments is an HE-AP or an EHT-AP, or is an access point applicable to a future-generation Wi-Fi standard.

The station is a wireless communications chip, a wireless sensor, a wireless communications terminal, or the like, and further is referred to as a user. For example, the station is a mobile phone supporting a Wi-Fi communications function, a tablet computer supporting a Wi-Fi communications function, a set-top box supporting a Wi-Fi communications function, a smart television supporting a Wi-Fi communications function, an intelligent wearable device supporting a Wi-Fi communications function, a vehicle-mounted communications device supporting a Wi-Fi communications function, or a computer supporting a Wi-Fi communications function. Optionally, the station supports the 802.11be standard. The station further supports a plurality of WLAN standards of the 802.11 family such as 802.11be, 802.11ax, 802.11ac, 802.11n, 802.11g, 802.11b, and 802.11a.

The access point in some embodiments is an HE-STA or an EHT-STA, or is a STA applicable to a future-generation Wi-Fi standard.

For example, the access point and the station is devices used in the Internet of vehicles, Internet of things nodes or sensors in the Internet of things (Internet of things, IoT), smart cameras, smart remote controls, and smart water meters in a smart home, and sensors in a smart city.

An AP station and a non-AP station in some embodiments alternatively is wireless communications devices that support parallel transmission on a plurality of links, for example, referred to as multi-link devices (multi-link devices) or multi-band devices (multi-band devices). Compared with a device that supports single-link transmission, the multi-link device has higher transmission efficiency and a higher throughput.

The multi-link device includes one or more affiliated stations STAs (affiliated STA). The affiliated STA is a logical station and operates on one link.

Although the embodiments are mainly described by using a network deployed based on IEEE 802.11 as an example, a person skilled in the art easily understands that various aspects of the embodiments is extended to other networks using various standards or protocols such as Bluetooth (Bluetooth), a high performance radio LAN (high performance radio LAN, HIPERLAN) (a wireless standard similar to the IEEE 802.11 standard and mainly used in Europe), a wide area network (WAN), a wireless local area network (wireless local area network, WLAN), a personal area network (personal area network, PAN), or other networks currently known or later developed. Therefore, the various aspects provided in some embodiments are applicable to any suitable wireless network regardless of coverage and a wireless access protocol.

The initiator and the responder for the OM negotiation in some embodiments further is collectively referred to as a communications apparatus. The communications apparatus includes a hardware structure and a software module, and the foregoing functions are implemented in a form of a hardware structure, a software module, or a combination of the hardware structure and the software module. A function in the foregoing functions are implemented in a form of a hardware structure, a software module, or a combination of the hardware structure and the software module.

FIG. 2 is a schematic diagram of a structure of a communications apparatus according to some embodiments. As shown in FIG. 2, the communications apparatus 200 includes a processor 201 and a transceiver 205, and optionally further includes a memory 202.

The transceiver 205 is referred to as a transceiver unit, a transceiver machine, a transceiver circuit, or the like, and is configured to implement a transceiver function. The transceiver 205 includes a receiver and a transmitter. The receiver is referred to as a receiver machine, a receiver circuit, or the like, and is configured to implement a receiving function. The transmitter is referred to as a transmitter machine, a transmitter circuit, or the like, and is configured to implement a sending function.

The memory 202 stores a computer program, software code, or instructions 204, where the computer program, the software code, or the instructions 204 further is referred to as firmware. The processor 201 controls a MAC layer and a PHY layer by running a computer program, software code, or instructions 203 in the processor 201, or by invoking the computer program, the software code, or the instructions 204 stored in the memory 202, to implement an OM negotiation method provided in the following embodiments. The processor 201 is a central processing unit (central processing unit, CPU), and the memory 302 is, for example, a read-only memory (read-only memory, ROM), or a random access memory (random access memory, RAM).

The processor 201 and the transceiver 205 described in some embodiments is implemented in an integrated circuit (integrated circuit, IC), an analog IC, a radio frequency integrated circuit RFIC, a mixed-signal IC, an application-specific integrated circuit (application-specific integrated circuit, ASIC), a printed circuit board (printed circuit board, PCB), an electronic device, or the like.

The communications apparatus 200 further includes an antenna 206. The modules included in the communications apparatus 200 are examples for description, and are not limited.

As described above, the communications apparatus described in the foregoing embodiment is an access point or a station. However, a scope of the communications apparatus described in some embodiments is not limited thereto, and the structure of the communications apparatus is unable to be limited in FIG. 2. The communications apparatus is an independent device or is a part of a larger device. For example, the communications apparatus is implemented in the following form:

(1) an independent integrated circuit (IC), a chip, a chip system, or a subsystem; (2) a set including one or more ICs, where optionally, the set of ICs further includes a storage component for storing data and instructions; (3) a module that is embedded in other devices; (4) a receiver, an intelligent terminal, a wireless device, a handheld device, a mobile unit, a vehicle-mounted device, a cloud device, an artificial intelligence device, or the like; or (5) others.

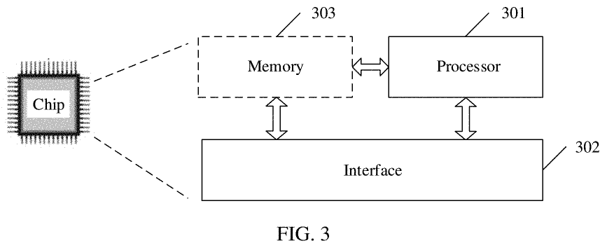

For the communications apparatus implemented in the form of the chip or the chip system, refer to a schematic diagram of a structure of a chip shown in FIG. 3. The chip shown in FIG. 3 includes a processor 301 and an interface 302. There is one or more processors 301, and there is a plurality of interfaces 302. Optionally, the chip or the chip system includes a memory 303.

The embodiments herein do not limit the protection scope and applicability of the claims. A person skilled in the art adaptively changes functions and deployments of elements in some embodiments, or omit, replace, or add various processes or components as appropriate without departing from the scope of embodiments.

With reference to the network system shown in FIG. 1 and the structures of the communications apparatus shown in FIG. 2 and FIG. 3, the following describes a technical solution of how to implement, as the initiator and the responder for the OM negotiation in the network system, OM negotiation provided in some embodiments.

For ease of understanding related content in the embodiments, the following describes some concepts related to the embodiments.

1. OM Negotiation

As described above, during or before a communications transmission process, one initiator (Initiator) that wants to change an operating mode (OM) transmits, to the responder (Responder), a MAC frame carrying a control subfield with an OMI to perform OM negotiation. After the OM negotiation is completed, the initiator and the responder perform transmission based on a negotiated OM. The OM usually includes channel width information or space-time stream number information.

2. MAC Frame

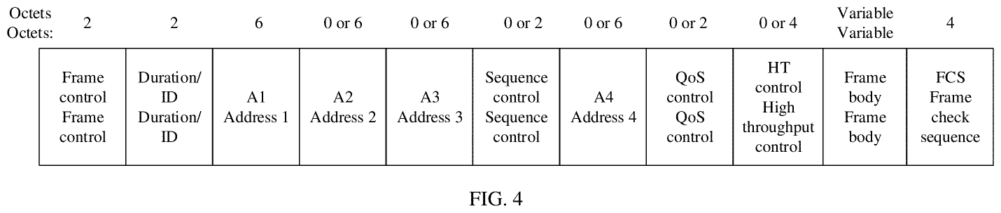

In a WLAN, the access point (Access Point, AP) and the station (Station, STA) transmit control signaling, management signaling, or data by using a medium access control (Medium Access Control, MAC for short) protocol data unit (MAC Protocol Data Unit, MPDU for short) or a MAC frame for short. A MAC frame format in the 802.11 standard is shown in FIG. 4.

3. Control Subfield

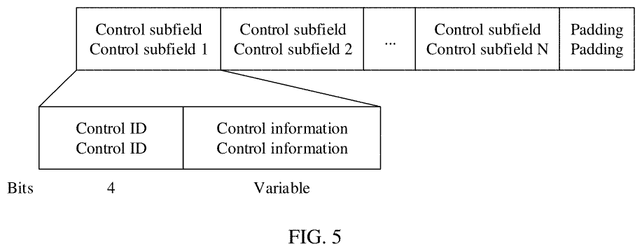

A control subfield is in a high throughput control field in a MAC header. The transmitter transmits some control information by using the control subfield. With a structure of one or more control identifiers plus control information, an aggregated control (Aggregated Control, A-control) subfield in a high efficient variant (currently including three forms: a high throughput variant, a very high throughput variant, and a high efficient variant) of a high throughput control field carries 1 to N pieces of control information. A structure of the A-control subfield is shown in FIG. 5. A control identifier indicates a type of control information. Currently, types of control subfields supported by 802.11ax are shown in Table 2.

TABLE 2
Type of a currently supported control subfield

| Controller | | Length of a control |
|---|---|---|
| ID | Description | information subfield |
| 0 | Triggered response scheduling | 26 |
| 1 | Operating mode | 12 |
| 2 | High efficiency link adaptation | 26 |
| 3 | Cache status reporting | 26 |
| 4 | Uplink power headroom | 8 |
| | (headroom) | |
| 5 | Channel width query report | 10 |
| 6 | Command and status | 8 |
| 7 to 14 | Reserved | |
| 15 | All-one sequence for extension | 26 |

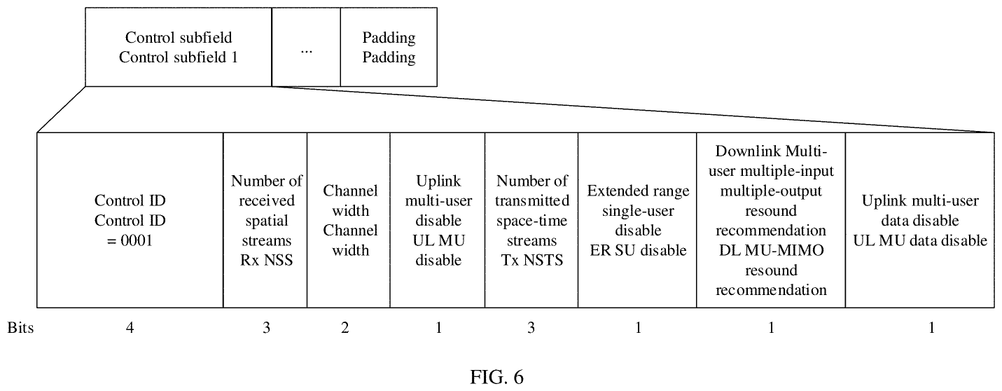

When a control identifier (control ID) of a control subfield is 0001, the control subfield corresponds to a control subfield indicating an OM in the 802.11ax standard, and a composition structure of the control subfield is shown in FIG. 6. Control information corresponding to the control subfield includes information such as the number of received spatial streams (receiver number of spatial streams, Rx NSS), channel width (channel width, CW), uplink multi-user disable (UL MU disable), the number of transmitted space-time streams (transmit number of spatial streams and time streams, Tx NSTS), extended range single-user disable (ER SU disable), downlink multi-user multiple-input multiple-output resound recommendation (DL MU-MIMO resound recommendation), and uplink multi-user data disable (UL MU Data disable).

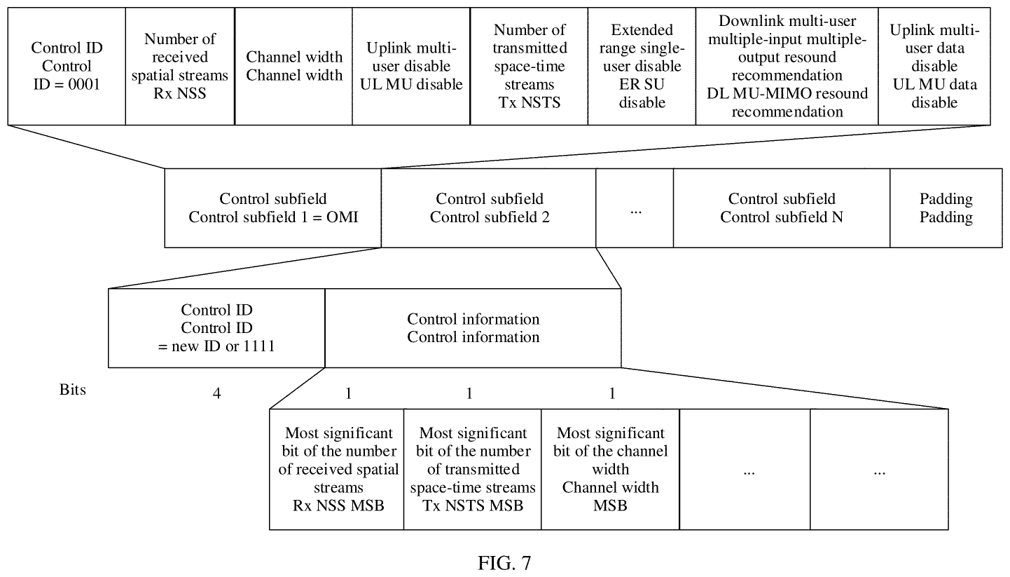

In some embodiments, as for the control subfield (control subfield), the control subfield is shown as two parts: control identifiers (control IDs) and control information (control information), and the control subfield then indicates various information in the control information, for example, as shown in FIG. 7. Alternatively, for brevity, the control subfield (control subfield) is simply shown as including a control identifier (control ID) and various control information, in other words, an indication for the control information (control information) is omitted, for example, as shown in FIG. 6.

4. Channel Width and Number of Spatial Streams/Number of Space-Time Streams

The OMI in some embodiments mainly indicates the channel width and the number of space-time streams in the OMI.

The channel width is used to indicate a channel width of a PPDU that is transmitted or received by the initiator for the OM (width is jointly indicated for transmitting and receiving).

The number of received space-time streams is used to indicate the number of space-time streams of a received physical layer protocol data unit (PHY Protocol Data Unit, PPDU) supported by the initiator for the OM, and is less than or equal to a maximum number of space-time streams supported by the initiator for the OM. In other words, the number of received space-time streams acts as a limit when the initiator serves as a receiver during data transmission, and acts as a limit on the number of space-time streams of data transmitted by the transmitter on the other side. The number of received or transmitted space-time streams is unable to exceed a capability range limited by the number of received space-time streams.

The number of transmitted space-time streams is used to indicate the number of space-time streams of a PPDU that is transmitted by the initiator for the OM. In other words, the number of transmitted space-time streams acts as a limit when the initiator serves as a transmitter during the data transmission. The number of transmitted space-time streams is unable to exceed a capability range limited by the number of transmitted space-time streams during data transmission.

In some embodiments, space-time block coding (Space-Time Block Coding, STBC) is considered in the number of space-time streams. For the 802.11ax standard, when STBC is used, the number of space-time streams is twice the number of spatial streams. When STBC is not used, the two numbers are the same. The two numbers are not distinguished in some embodiments. In descriptions, if not specified, the two numbers are usually represented by the number of space-time streams. In some embodiments, the space-time stream number indication information indicates the number of spatial streams, or the number of space-time streams, or partially indicate the number of space-time streams, and partially indicate the number of spatial streams. For example, for a transmitter, the space-time stream number indication information indicates the number of transmitted space-time streams. For a receiver, the space-time stream number indication information indicates the number of received spatial streams. Alternatively, for a transmitter, the space-time stream number indication information indicates the number of received spatial streams. For a receiver, the space-time stream number indication information indicates the number of transmitted space-time streams.

In some embodiments, a technical solution of OM negotiation different from the 802.11ax standard is implemented by extending some control subfields or related control information in a MAC frame in the 802.11ax standard, or adding control subfields.

With reference to accompanying drawings and the foregoing related concept descriptions, the following further describes related content of the OM negotiation method in the network system shown in FIG. 1 implemented by the initiator and the responder for the OM negotiation provided in some embodiments.

The technical solution of the OM negotiation provided in some embodiments is as follows:

The initiator sends an operating mode indication OMI to the responder. The OMI includes at least either of channel width indication information and space-time stream number indication information.

A capability range of a channel width indicated by the channel width indication information is greater than 160 MHz. A capability range of the number of space-time streams indicated by the space-time stream number indication information is greater than 8.

Alternatively, a capability range of a channel width indicated by the channel width indication information is less than or equal to 160 MHz. A capability range of the number of space-time streams indicated by the space-time stream number indication information is greater than 8.

Alternatively, a capability range of a channel width indicated by the channel width indication information is greater than 160 MHz. A capability range of the number of space-time streams indicated by the space-time stream number indication information is smaller than or equal to 8.

In other words, in some embodiments, when the OMI includes the channel width indication information and the space-time stream number indication information, there is a plurality of combination relationships between the channel width range indicated by the channel width indication information and the range of the number of space-time streams indicated by the space-time stream number indication information. For example:

The channel width range indicated by the channel width indication information is greater than 160 MHz. However, the range of the number of space-time streams indicated by the space-time stream number indication information is 1 to 8 (that the number of space-time streams is 1 to 8 is indicated by enhanced space-time stream number indication information in some embodiments, or space-time stream number indication information in the 802.11ax standard and a previous standard).

Alternatively, the channel width range indicated by the channel width indication information is greater than or equal to 20 MHz and less than or equal to 160 MHz (that the channel width range is less than or equal to 160 MHz is indicated by enhanced channel width indication information in some embodiments, or channel width indication information in the 802.11ax standard and a previous standard). The range of the number of space-time streams indicated by the space-time stream number indication information is 1 to 16.

Alternatively, the channel width range indicated by the channel width indication information is greater than or equal to 20 MHz and less than or equal to 160 MHz (that the channel width range is less than or equal to 160 MHz is indicated by enhanced channel width indication information in some embodiments, or channel width indication information in the 802.11ax standard and a previous standard). The range of the number of space-time streams indicated by the space-time stream number indication information is 1 to 8 (that the number of space-time streams is 1 to 8 is indicated by enhanced space-time stream number indication information in some embodiments, or space-time stream number indication information in the 802.11ax standard and a previous standard).

Alternatively, the channel width range indicated by the channel width indication information is greater than 160 MHz. The range of the number of space-time streams indicated by the space-time stream number indication information is 1 to 16.

The responder sends an acknowledgment message to the initiator. After receiving the acknowledgment message, the initiator performs transmission with the responder.

For a channel width indicated by the OMI, the initiator and the responder perform data transmission within a range not exceeding the channel width indicated by the channel width indication information.

For the number of space-time streams indicated by the OMI, the number of received space-time streams is used to indicate the number of space-time streams of a received PPDU supported by the initiator for the OM, and is less than or equal to a maximum number of space-time streams supported by the initiator for the OM. In other words, the number of received space-time streams acts as a limit when the initiator serves as a receiver during data transmission, and acts as a limit on the number of space-time streams of data transmitted by the transmitter on the other side. The number of received or transmitted space-time streams is unable to exceed a capability range limited by the number of received space-time streams.

The number of transmitted space-time streams is used to indicate the number of space-time streams of a PPDU that is transmitted by the initiator for the OM. In other words, the number of transmitted space-time streams acts as a limit when the initiator serves as a transmitter during the data transmission. The number of transmitted space-time streams is unable to exceed a capability range limited by the number of transmitted space-time streams during the data transmission. As described above, a technical solution of the enhanced OM negotiation provided in some embodiments is mainly implemented based on control information carried in the MAC frame. In a possible implementation, this technical solution is implemented by using a control subfield, in other words, the OMI is carried in control information corresponding to a control subfield. The control information includes at least either of the channel width indication information and the space-time stream number indication information. Certainly, in some embodiments, another subfield of the MAC frame is used to implement the enhanced OM negotiation.

The control subfield is used to implement the enhanced OM negotiation in the following two modes:

First, the technical solution of the enhanced OM negotiation is implemented by using a control subfield provided in an existing 802.11ax standard as a basic indication subfield, and adding a new extension indication subfield.

Second, the technical solution of the enhanced OM negotiation is implemented by extending OM information that is indicated by the control subfield.

The enhanced OM negotiation in some embodiments is described from the perspective of comparing with a capability range of OM negotiation supported by the 802.11ax. A capability range of a channel width of the enhanced OM negotiation is greater than 160 MHz, and a capability range of the number of space-time streams of the enhanced OM negotiation is greater than 8.

Without loss of generality, the capability range of the channel width indicated by the channel width indication information in some embodiments is a range of a maximum value of the channel width that is indicated by the channel width indication information, but an actual channel width indicated by the channel width indication information is less than the capability range of the channel width.

For example, the actual channel width indicated by the channel width indication information is any one of 20 MHz, 40 MHz, 80 MHz, 160 MHz, 240 MHz, or 320 MHz, and the maximum value of the channel width is 320 MHz. In some embodiments, the capability range of the channel width indicated by the channel width indication information is greater than 160 MHz, which further is referred to as an enhanced width indication subsequently, for example, an enhanced channel width indication.

In some embodiments, the channel width is contiguous, or noncontiguous. For example, 320 MHz is 160 MHz+160 MHz. 240 MHz is 80 MHz+160 MHz or 160 MHz+80 MHz.

In some embodiments, with development of technologies, the capability range of the channel width that is indicated by the channel width indication information provided in some embodiments alternatively is greater than 320 MHz, for example, 480 MHz, 640 MHz, 800 MHz, 960 MHz, 1120 MHz or 1280 MHz.

Correspondingly, the capability range of the number of space-time streams indicated by the space-time stream number indication information in some embodiments is a range of a maximum value of the number of space-time streams that is indicated by the space-time stream number indication information, but an actual number of space-time streams indicated by the space-time stream number indication information is less than the capability range of the number of space-time streams.

For example, the actual number of space-time streams indicated by the space-time stream number indication information is any one of 1, 2, 3, 4, 5, 6, 7, 8, 9, 10, 11, 12, 13, 14, 15, or 16, and the maximum value of the number of space-time streams is 16. In some embodiments, the capability range of the number of space-time streams indicated by the space-time stream number indication information is greater than 8, which further is referred to as an enhanced space-time stream number indication subsequently, for example, an enhanced Rx NSS or Tx NSTS indication.

With development of technologies, the capability range of the space-time stream number indication information that is indicated by the space-time stream number indication information provided in some embodiments alternatively is greater than 16, for example, 20, 24, 32, 48, or 64.

In an optional implementation, the space-time stream number indication information includes at least either of indication information of the number of transmitted space-time streams and indication information of the number of received space-time streams. In this way, the space-time stream number indication information flexibly indicates the transmitter and the receiver for data transmission to use a same or different number of space-time streams for transmission.

In another optional implementation, the space-time stream number indication information indicates both the number of transmitted space-time streams and the number of received space-time streams. In this way, a minimum number of bits are used to simultaneously indicate a same number of space-time streams used by the transmitter and the receiver for data transmission.

In another optional implementation, the number of space-time streams indicated by the space-time stream number indication information is less than or equal to the number of space-time streams of a preset channel width value. The preset channel width value is 80 MHz or 160 MHz.

The number of space-time streams corresponding to another channel width is derived according to a preset condition. For example, a greater channel width indicates a smaller number of space-time streams. For another example, by using the following formula (1), the number of space-time streams whose channel width of the PPDU is a value that is derived based on the indicated number of space-time streams:

Round down (an NSS or an NSTS in the OMI indicated by the control subfield*(a maximum value of an NSS or an NSTS supported when the channel width of the PPDU is a value/a maximum value of an NSS or an NSTS supported when the channel width of the PPDU is the preset channel width value)) Formula (1)

The maximum value of the NSS or the NSTS supported when the channel width of the PPDU is a value, and the maximum value of the NSS or the NSTS supported when the channel width of the PPDU is the preset channel width value is obtained in advance by using capability information.

For example, assuming the NSS or the NSTS in the OMI indicated by the control subfield is 4, when the channel width of the PPDU is 320 MHz, a maximum number of NSSs or NSTSs supported by a STA is 2; when a preset channel width value of the PPDU is 80 MHz, the maximum number of NSSs or NSTSs supported by the STA is 8. Therefore, according to the formula (1), when the channel width of the PPDU is 320 MHz, the number of space-time streams that is supported by the STA=round down (4*(2/8))=1.

For another example, assuming the NSS or the NSTS in the OMI indicated by the control subfield is 4, when the channel width of the PPDU is 320 MHz, a maximum number of NSSs or NSTSs supported by a STA is 2; when a preset channel width value of the PPDU is 160 MHz, the maximum value of NSS or NSTS supported by the STA is 4. Therefore, derivation is according to the formula (1) that when the channel width of the PPDU is 320 MHz, the number of space-time streams that is supported by the STA=round down (4*(2/4))=2.

In another optional implementation, when the channel width indication information indicates different channel widths, the space-time stream number indication information indicates a same number of space-time streams. For example, when the channel width indication information indicates any one of 20 MHz, 40 MHz, 80 MHz, 160 MHz, 240 MHz, or 320 MHz, the number of space-time streams indicated by the space-time stream number indication information is 8.

In addition, when negotiating different channel widths, the initiator and the responder are configured to use a same number of space-time streams. By default, the number of space-time streams are the same as a supported maximum or minimum number of control streams that is previously reported by the responder. In this case, the space-time stream number indication information further is omitted.

In addition, after completing negotiation of the channel width and the number of space-time streams through one OM negotiation, the initiator and the responder omits indication information of the number of transmitted space-time streams during subsequent negotiation on a change in the channel width, and agree by default that the number of subsequent space-time streams is the same as the number of previously negotiated space-time streams.

The foregoing descriptions are applicable to some embodiments. To avoid repetition, descriptions are properly omitted below.

With reference to the network system shown in FIG. 1 and the schematic diagram of the structure of the communications apparatus that acts as the initiator or the responder provided in FIG. 2, the following describes, by using more embodiments, the technical solution of the OM negotiation provided in some embodiments.

In the following embodiment, for example, the AP in FIG. 1 is used as the initiator for OM negotiation and the STA 1 is used as the responder for the OM negotiation. Other cases are similar and are not listed one by one herein.

In some embodiments, a technical solution of the enhanced OM negotiation in which an OMI sent by the AP to the STA 1 is jointly indicated by using two or more control subfields when the AP performs OM negotiation with the STA 1.

As the initiator for the OM negotiation, the AP transmits the OMI to the STA 1 by using the transceiver (205 shown in FIG. 2) of the AP. The OMI is carried in control information corresponding to the control subfield.

As the responder for the OM negotiation, the STA 1 receives the OMI from the AP by using the transceiver (also 205 shown in FIG. 2) of the STA 1.

As shown in FIG. 7, the control subfield that carries the OMI includes a first control subfield and a second control subfield. The first control subfield is an OMI basic indication subfield, in other words, the first control subfield is a control subfield indicating OMI in the 802.11ax standard. The second control subfield is an OMI extension indication subfield, in other words, the second control subfield is a control subfield that is different from the control subfield indicating OMI in the 802.11ax standard. The first control subfield and the second control subfield jointly indicate an enhanced OMI. In some embodiments, in comparison with a range that is indicated by the OMI in the 802.11ax standard, the enhanced OMI indicates a channel width in a greater range and more space-time streams.

Control information corresponding to the first control subfield and the second control subfield separately includes at least either of the channel width indication information (channel width) and the space-time stream number indication information (for example, Rx NSS/the Tx NSTS).

In an implementation, a value of a control identifier (control ID) corresponding to the first control subfield is 1 (represented as 0001 in binary, and shown as control ID=0001 in the figure), and is used as an OM indication in the 802.11ax standard. As shown in FIG. 6 and FIG. 7, in the control information corresponding to the first control subfield whose control ID is 0001, the number of bits of first channel width indication information that indicates a channel width is 2, the number of bits of first space-time stream number indication information that indicates the number of space-time streams is 3. For example, the number of bits of Rx NSS is 3, and the number of bits of Tx NSTS is 3.

In a possible implementation, a value of a control identifier corresponding to the second control subfield is any one of 7 to 15.

In some embodiments, as shown in Table 2, 7 to 15 are applicable to a control identifier of reserved control subfields in the 802.11ax standard. In some embodiments, control subfields corresponding to one or two of the control identifiers is used as extended control subfields, and jointly indicate the enhanced OM with the first control subfield whose control identifier is 1.

The second control subfield herein is one control subfield, or is increased to two or more control subfields as called for.

In another implementation, a value of a control identifier corresponding to the second control subfield is 1, in other words, is the same as that of the control identifier corresponding to the first control subfield. In this case, for the initiator and the responder, when the control identifier of the first control subfield is 1, a control subfield that follows the first control subfield and whose control identifier is 1 is jointly parsed with the first control subfield by default, to obtain the enhanced OM. Alternatively, the initiator and the responder consecutively receive two control subfields whose control identifiers are 1 by default, and the two control subfields need to be jointly parsed to obtain the enhanced OM.

In yet another implementation, the value of the control identifier corresponding to the first control subfield is 15, and the value of the control identifier corresponding to the second control subfield is 1, or any one of 7 to 15. In this case, the first control subfield whose control identifier is 15 is also similar to a control subfield whose control identifier is 1 in the 802.11ax standard in terms of function for the OM negotiation. For the initiator and the responder, when the control identifier of the first control subfield is 15, a control subfield that follows the first control subfield is jointly parsed with the first control subfield by default, to obtain the enhanced OM.

In FIG. 7, for example, the second control subfield is one control subfield. The number of bits of second channel width indication information that is in control information corresponding to the second control subfield and that indicates a channel width is 1. For example, channel width MSB is 1 bit in FIG. 7. In this way, the first channel width indication information and the second channel width indication information are 3 bits in total, and jointly indicates an enhanced channel width range of 20 MHz to 320 MHz.

As shown in Table 3:

TABLE 3
Enhanced channel width indication

| Channel width | Channel width | |
|---|---|---|
| indication | indication | |
| information in | information in | |
| a first control | a second control | |
| subfield (Channel | subfield (Channel | Description (supported channel |
| Width) | Width MSB) | width) |
| 00 | 0 | 20 MHz |
| 01 | 0 | 40 MHz |
| 10 | 0 | 80 MHz |
| 11 | 0 | 160 MHz or 80 + 80 MHz |
| | | (noncontiguous 160 MHz, and |
| | | whether 160 MHz or 80 + 80 |
| | | MHz is used is predefined by |
| | | another management frame) |
| 00 | 1 | 240 MHz or 160 + 80 MHz |
| 01 | 1 | 320 MHz or 160 + 160 MHz |
| 10 | 1 | Reserved |
| 11 | 1 | Reserved |

Table 3 is described by using an example in which a bit of the second channel width indication information is a most significant bit (Most Significant Bit, MSB) in 3 bits formed by 2 bits of the first channel width indication information and 1 bit of the second channel width indication information. Similarly, a bit of the second channel width indication information is a least significant bit (Least Significant Bit, LSB) in 3 bits formed by 2 bits of the first channel width indication information and 1 bit of the second channel width indication information. As shown in Table 4:

TABLE 4
Enhanced channel width indication

| Channel width | Channel width | |
|---|---|---|
| indication | indication | |
| information in | information in | |
| a second control | a first control | |
| subfield (Channel | subfield (Channel | Description (supported channel |
| Width LSB) | Width) | width) |
| 0 | 00 | 20 MHz |
| 0 | 01 | 40 MHz |
| 0 | 10 | 80 MHz |
| 0 | 11 | 160 MHz or 80 + 80 MHz |
| | | (noncontiguous 160 MHz, and |
| | | whether 160 MHz or 80 + 80 |
| | | MHz is used is predefined by |
| | | another management frame) |
| 1 | 00 | 240 MHz or 160 + 80 MHz |
| 1 | 01 | 320 MHz or 160 + 160 MHz |
| 1 | 10 | Reserved |
| 1 | 11 | Reserved |

Table 3 and Table 4 are examples. In an implementation, there are other combinations of correspondences between the channel width and eight values characterized by 3 bits formed by 2 bits of the first channel width indication information and 1 bit of the second channel width indication information. Details are not described herein.

In some embodiments, with development of technologies, the channel width range jointly indicated by the first channel width indication information and the second channel width indication information is greater, for example, 20 MHz to 640 MHz, or even 20 MHz to 1280 MHz. The number of bits of the second channel width indication information remains 1, or increase to 2, 3, or the like accordingly. Alternatively, the second channel width indication information remaining 1 bit, the first channel width indication information and the second channel width indication information indicates some greater channel widths, for example, 16 channel widths from 20 MHz to 640 MHz.

In this way, after the STA 1 serving as the responder receives the first control subfield and the second control subfield by using the transceiver 205 of the STA 1, the processor 201 of the STA 1 jointly parses the first channel width indication information and the second channel width indication information in the first control subfield and the second control subfield, to obtain the channel width indicated by the AP to the STA 1.

For the space-time stream number indication information, the number of bits of first space-time stream number indication information that is in the control information corresponding to the first control subfield and that indicates the number of space-time streams is 3. The number of bits of second space-time stream number indication information that is in control information corresponding to the second control subfield and that indicates the number of space-time streams is 1. A total number of bits of the first space-time stream number indication information and the second space-time stream number indication information is 4, and a range of the number of space-time streams jointly indicated is 1 to 16.

As shown in Table 5:

TABLE 5
Enhanced Tx NSTS or enhanced Rx NSS indication

| Number of space-time | Number of space-time | |
|---|---|---|
| streams in the first | streams in the second | Description |
| control subfield (Tx | control subfield (Tx | (supported Tx |
| NSTS/Rx NSS) | NSTS/Rx NSS MSB) | NSTS or Rx NSS) |
| 000 | 0 | 1 |
| 001 | 0 | 2 |
| 010 | 0 | 3 |
| 011 | 0 | 4 |
| 100 | 0 | 5 |
| 101 | 0 | 6 |
| 110 | 0 | 7 |
| 111 | 0 | 8 |
| 000 | 1 | 9 |
| 001 | 1 | 10 |
| 010 | 1 | 11 |
| 011 | 1 | 12 |
| 100 | 1 | 13 |
| 101 | 1 | 14 |
| 110 | 1 | 15 |
| 111 | 1 | 16 |

Table 5 is described by using an example in which 1 bit of the second space-time stream number indication information is a most significant bit in 3 bits formed by 2 bits of the first space-time stream number indication information and 1 bit of the second space-time stream number indication information. Similarly, the bit of the second channel width indication information is a least significant bit (LSB) in 3 bits formed by 2 bits of the first channel width indication information and 1 bit of the second channel width indication information. As shown in Table 6:

TABLE 6
Enhanced Tx NSTS or enhanced Rx NSS indication

| Number of space-time | Number of space-time | |
|---|---|---|
| streams in the second | streams in the first | Description |
| control subfield (Tx | control subfield (Tx | (supported Tx |
| NSTS/Rx NSS MSB) | NSTS/Rx NSS) | NSTS or Rx NSS) |
| 0 | 000 | 1 |
| 0 | 001 | 2 |
| 0 | 010 | 3 |
| 0 | 011 | 4 |
| 0 | 100 | 5 |
| 0 | 101 | 6 |
| 0 | 110 | 7 |
| 0 | 111 | 8 |
| 1 | 000 | 9 |
| 1 | 001 | 10 |
| 1 | 010 | 11 |
| 1 | 011 | 12 |
| 1 | 100 | 13 |
| 1 | 101 | 14 |
| 1 | 110 | 15 |
| 1 | 111 | 16 |

Table 5 and Table 6 are examples. In an implementation, there are other combinations of correspondences between the channel width and 16 values characterized by 4 bits formed by 3 bits of the first space-time stream number indication information and 1 bit of the second space-time stream number indication information. Details are not described herein.

In some embodiments, with development of technologies, the range of the number of space-time streams jointly indicated by the first space-time stream number indication information and the second space-time stream number indication information is greater, for example, 1 to 32, or even 1 to 64. The number of bits of the second space-time stream number indication information remains 1, or increase to 2, 3, or the like accordingly. Alternatively, the second space-time stream number indication information remaining 1 bit, the second space-time stream number indication information indicates 1 to 32 or 1 to 64, for example, 16 values from 1 to 32.

In a possible implementation, the number of space-time streams jointly indicated by the first space-time stream number indication information and the second space-time stream number indication information is less than or equal to the number of space-time streams of a preset channel width value.

The preset channel width value is 80 MHz or 160 MHz.

A method for deriving the number of space-time streams corresponding to another channel width and beneficial effects thereof have been described in detail in the foregoing general description. Details are not described herein again.

In still another possible implementation, when the first channel width indication information and the second channel width indication information jointly indicate different channel widths, the first space-time stream number indication information and the second space-time stream number indication information jointly indicate a same number of space-time streams.

In other words, the first control subfield and the second control subfield is used to indicate different channel widths and a same number of space-time streams. Beneficial effects of indicating the same number of space-time streams have been described in detail in the foregoing general description. Details are not described herein again.

In addition, in another implementation, the number of space-time streams jointly indicated by the first space-time stream number indication information and the second space-time stream number indication information is the number of received space-time streams, or the number of transmitted space-time streams. In other words, the number of received space-time streams and the number of transmitted space-time streams are combined into one piece of indication information. For example, the Rx NSS and the Tx NSTS shown in FIG. 6 is combined into one piece of indication information, and occupy 3 bits in total. The Rx NSS MSB and the Tx NSTS MSB shown in FIG. 7 is combined into one piece of indication information, and occupy 1 bit in total. This saves indication overheads.

In another implementation, the first space-time stream number indication information still separately indicates the number of received space-time streams and the number of transmitted space-time streams. For example, the Rx NSS and the Tx NSTS shown in FIG. 6 each occupy 3 bits. The second space-time stream number indication information indicates both the number of received space-time streams and the number of transmitted space-time streams. For example, the Rx NSS MSB and the Tx NSTS MSB shown in FIG. 7 is combined into one piece of indication information, and occupy 1 bit in total. The 1 bit of the second space-time stream number indication information is separately combined with two 3 bits of the first space-time stream number indication information to jointly indicate the number of space-time streams. This also saves the indication overheads to some extent.

In conclusion, in the OM negotiation technology implemented by the initiator AP and the responder STA 1 in a Wi-Fi network system provided, based on the OMI basic indication subfield, the other control subfield is used as the OMI extension indication subfield. In this case, maximum compatibility with the 802.11ax standard is achieved, and OM negotiation on a greater channel width or more space-time streams is implemented at low overheads.

If less than one of OMs of channel width, Tx NSTS, and Rx NSS claimed by the transmitter for communications exceeds a maximum value supported by the 802.11ax standard, the transmitter does not need to send the second control subfield (the OMI extension indication subfield), but sends the first control subfield (that is, an OMI basic indication subfield corresponding to control ID=0001 in the 802.11ax standard).

If the receiver for communications finds the first control subfield (the OMI basic indication subfield) in the A-control subfield, the receiver obtains, from the OM control subfield, an OM indicated by the initiator for the OM negotiation. If the receiver finds both the OMI basic indication subfield and the OMI extension indication subfield, the receiver jointly reads an enhanced OM indicated by the OMI initiator.

The foregoing describes how to implement enhanced OM negotiation by using the two control fields. The OM negotiation technology in some embodiments further is implemented by using one control subfield, which is described separately in a plurality of embodiments below.

In some embodiments, a technical solution of the enhanced OM negotiation in which an OMI sent by the AP to the STA 1 is indicated by using one control subfield when the AP performs OM negotiation with the STA 1.

In some embodiments, the control subfield is referred to as a third control subfield. Correspondingly, the OMI is carried in control information corresponding to the third control subfield. The control information includes at least either of third channel width indication information and third space-time stream number indication information.

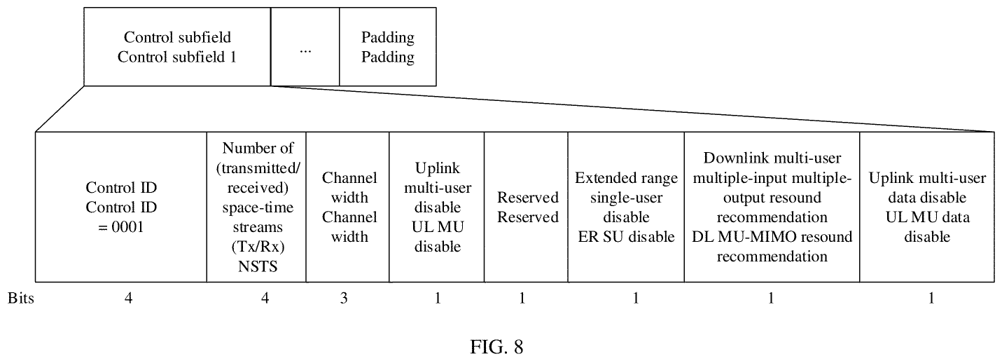

In an implementation, as shown in FIG. 8, the third channel width indication information (channel width) in control information corresponding to the third control subfield is 3 bits, and indicates a channel width range from 20 MHz to 320 MHz. The third space-time stream number indication information (indicating both Rx NSS and Tx NSTS) is 4 bits, and indicates that a range of the number of transmitted space-time streams and the number of received space-time streams is 1 to 16. FIG. 8 is described by using an example in which a value of a control identifier of the third control subfield is 1. Certainly, a control subfield corresponding to a value of a control identifier is further recharacterized to indicate the enhanced OM.

In an embodiment shown in FIG. 8, the Rx NSS and the Tx NSTS are indicated by using one piece of third space-time stream number indication information. This saves 2*3−4=2 bits compared with the 802.11ax standard in which the Rx NSS and the Tx NSTS are separately indicated by using 3 bits. However, compared with 2-bit channel width in the 802.11ax standard, there is 1 bit more in the 3-bit third channel width indication information (channel width). Therefore, in general, compared with the 802.11ax standard, the enhanced OM negotiation is implemented without increasing the number of bits in the third control subfield.

A sequence of control sub-information in the control information corresponding to the control subfield shown in FIG. 8 is an example. There is another variation. the number of bits of another control sub-information further is adaptively changed. Compared with the 802.11ax standard, a sequence of uplink multi-user disable (UL MU disable) of the control subfield shown in FIG. 8 is changed. Certainly, in another implementation, the sequence is the same as that of the control subfield in the 802.11ax standard.

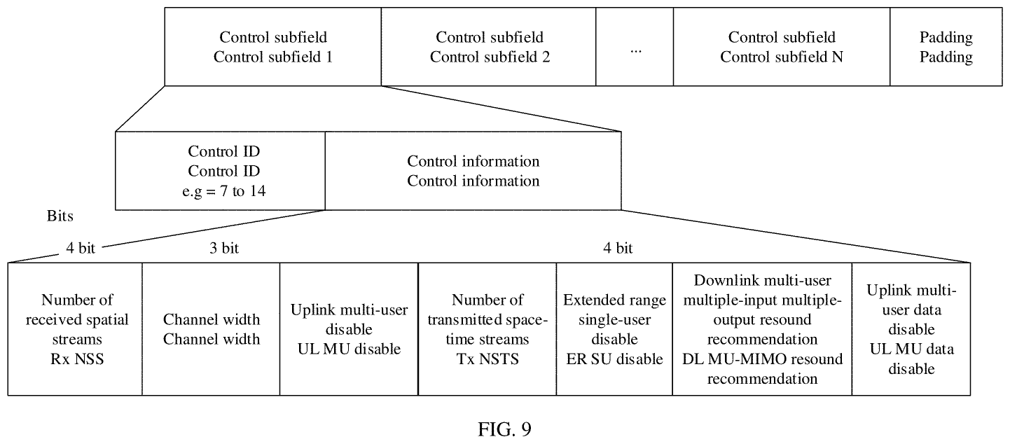

In an implementation, as shown in FIG. 9, the third channel width indication information (channel width) in control information corresponding to the third control subfield (control subfield 1 in FIG. 9) is 3 bits, and indicates a channel width range from 20 MHz to 320 MHz. The third space-time stream number indication information (the Rx NSS or the Tx NSTS) is 4 bits, and indicates that a range of the number of space-time streams is 1 to 16. FIG. 9 is described by using an example in which a value of a control identifier of the third control subfield is 7 to 14. For example, a control subfield whose control identifier is 8 is used to indicate the enhanced OM.

In this implementation, channel width in control information corresponding to any control subfield corresponding to control ID=7 to 14 is set to 3 bits in the 802.11ax standard, so that an indication of a greater width range is supported. In addition, the Rx NSS or the Tx NSTS that occupies 3 bits in the 802.11ax standard are set to 4 bits, so that an indication of a greater range of the number of space-time streams are supported.

For an initiator and a responder that support the 802.11ax, control information corresponding to a control subfield corresponding to control ID=1 is parsed, to obtain at least either of the channel width and the Rx NSS or the Tx NSTS. For an initiator and a responder that support a standard after the 802.11ax standard, control information corresponding to a control subfield corresponding to control ID=8 is parsed, to obtain at least either of the channel width and the Rx NSS or the Tx NSTS.

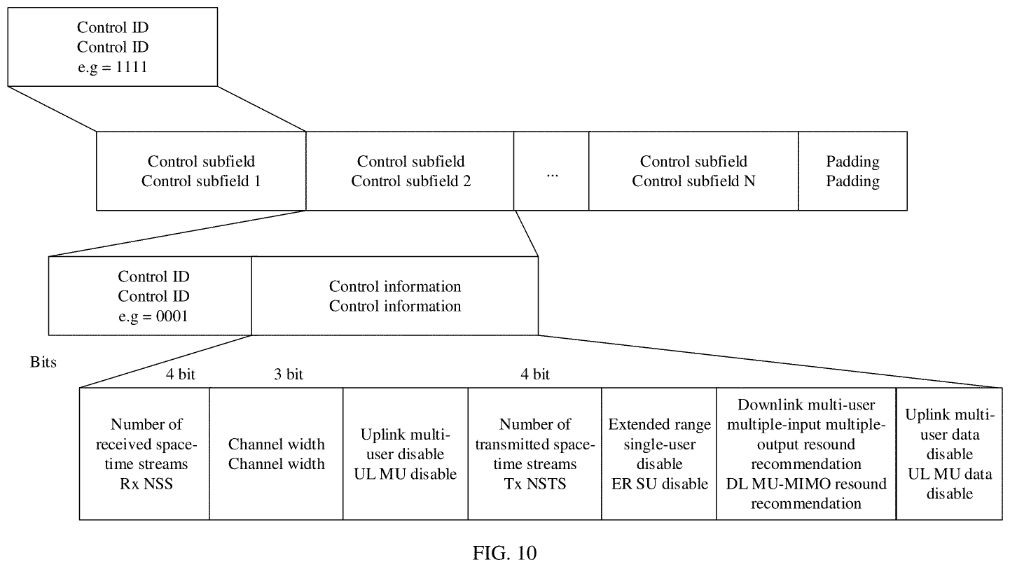

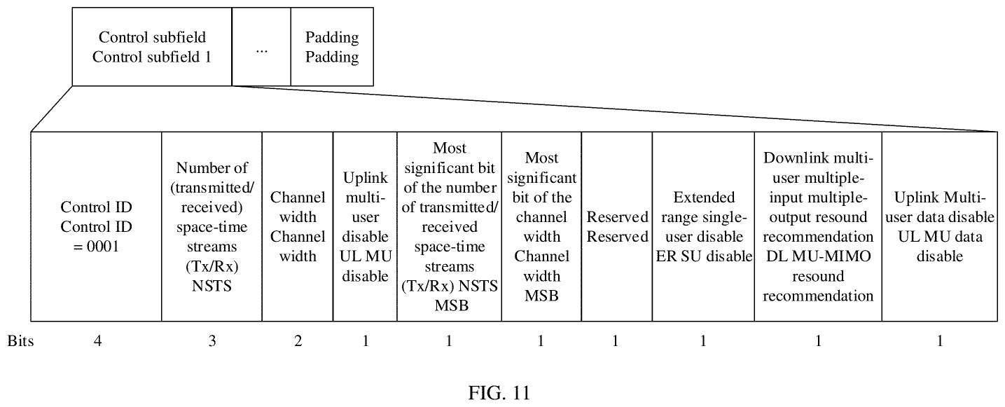

In still another implementation, as shown in FIG. 10, the third control subfield is one control subfield located after a control subfield whose identifier value is 15. The control subfield herein (a control subfield 1 shown in FIG. 10) includes a control ID, for example, a control ID=1111, has a function of extension, and does not include corresponding control information (control information). Therefore, a subsequent control ID is any value, in other words, the value of the identifier of the third control subfield is any one of 0 to 15.

For example, a control ID of the third control subfield is the same as a control subfield that is characterized in the 802.11ax standard and that is used for OM negotiation, in other words, control ID=0001. Control information corresponding to the third control subfield carries an enhanced OM, where the number of bits of the Rx NSS, the channel width, and the Tx NSTS are at least 4, 3, and 4 respectively. A control subfield with another function is similar for alignment between the 802.11ax standard and a subsequent standard.

In some embodiments, the third channel width indication information indicates a greater channel width range, for example, indicate 480 MHz, 640 MHz, 800 MHz, 960 MHz, 1120 MHz. The third space-time stream number indication information indicates a greater range of the number of space-time streams, for example, 1 to 32, or 1 to 64. The number of space-time streams is 20, 24, 32, 48, 64, or the like.

Optionally, the number of space-time streams indicated by the third space-time stream number indication information is less than or equal to the number of space-time streams of a preset channel width value. The preset channel width value is 80 MHz or 160 MHz.

A method for deriving the number of space-time streams corresponding to another channel width and beneficial effects thereof have been described in detail in the foregoing general description. Details are not described herein again.

Optionally, when the third channel width indication information indicates different channel widths, the third space-time stream number indication information indicate a same number of space-time streams.

In other words, the third control subfield is used to indicate different channel widths and a same number of space-time streams. Beneficial effects of indicating the same number of space-time streams have been described in detail in the foregoing general description. Details are not described herein again.

In addition, in another implementation, the number of space-time streams indicated by the third space-time stream number indication information is the number of received space-time streams, or the number of transmitted space-time streams. In other words, the number of received space-time streams and the number of transmitted space-time streams are combined into one piece of indication information. For example, the Rx NSS and the Tx NSTS shown in FIG. 9 or FIG. 10 is combined into one piece of indication information, and occupy 4 bits in total. This saves indication overheads.

In some embodiments, in the 802.11ax standard, the control subfield whose identifier value is 15 is used as an identifier point indicating the enhanced OMI. In this case, the responder for the OM negotiation is configured to use the identifier point as an identifier, and identify a control subfield following the control subfield whose identifier value is 15 as an enhanced OM control subfield. This supports negotiation on a greater channel width and a greater number of space-time streams. In addition, some embodiments are highly compatible with the 802.11ax standard. For an initiator and a responder that support or do not support the 802.11ax standard, a control subfield corresponding to control ID=0001 is parsed, to obtain OM information.

In some embodiments, a technical solution of the enhanced OM negotiation in which an OMI sent by the AP to the STA 1 is indicated by using one control subfield when the AP performs OM negotiation with the STA 1.

In some embodiments, the control subfield is still referred to as a third control subfield. Correspondingly, the OMI is carried in control information corresponding to the third control subfield. The control information includes at least either of third channel width indication information and third space-time stream number indication information.

In an implementation, the third channel width indication information in the control information corresponding to the third control subfield is 3 bits.

Different from other embodiments, in the control information corresponding to the third control subfield, the third channel width indication information includes first channel width indication sub-information and second channel width indication sub-information. The first channel width indication sub-information (the channel width as shown in FIG. 11) is 2 bits. The second channel width indication sub-information (the channel width MSB as shown in FIG. 11) is 1 bit. The first channel width indication sub-information and the second channel width indication sub-information jointly indicate a channel width.

FIG. 11 is described by using an example in which 1 bit of the second channel width indication sub-information is used as an MSB in 3 bits of the third channel width indication information formed by 2 bits of the first channel width indication sub-information and 1 bit of the second channel width indication sub-information. In another implementation, 1 bit of the second channel width indication sub-information further is used as an LSB in 3 bits of the third channel width indication information formed by 2 bits of the first channel width indication sub-information and 1 bit of the second channel width indication sub-information.

In this case, the responder jointly parses first channel width indication sub-information and second channel width indication sub-information, to obtain an indicated channel width.

Different from some embodiments, the third space-time stream number indication information includes first space-time stream number indication sub-information and second space-time stream number indication sub-information. The first space-time stream number indication sub-information (the Tx NSTS or the Rx NSTS as shown in FIG. 11) is 3 bits. The second space-time stream number indication sub-information (the Tx NSTS MSB and the Rx NSTS MSB as shown in FIG. 11) is 1 bit. The first space-time stream number indication sub-information and the second space-time stream number indication sub-information jointly indicate the number of space-time streams.

FIG. 11 is described by using an example in which 1 bit of the second space-time stream number indication sub-information is used as an MSB in 4 bits of the third space-time stream number indication information formed by 3 bits of the first space-time stream number indication sub-information and 1 bit of the second space-time stream number indication sub-information. In another implementation, 1 bit of the second space-time stream number indication sub-information alternatively is used as an LSB in 4 bits of the third space-time stream number indication information formed by 3 bits of the first space-time stream number indication sub-information and 1 bit of the second space-time stream number indication sub-information.

In this case, the responder jointly parses the first space-time stream number indication sub-information and the second space-time stream number indication sub-information, to obtain an indicated number of space-time streams.

In a possible implementation, an identifier value corresponding to the third control subfield is any one of 0 to 15. For example, the identifier value corresponding to the third control subfield is 1.

Optionally, the third control subfield is one control subfield located after a control subfield whose identifier value is 15.

Optionally, the number of space-time streams jointly indicated by the first space-time stream number indication sub-information and the second space-time stream number indication sub-information is less than or equal to the number of space-time streams of a preset channel width value. The preset channel width value is 80 MHz or 160 MHz.

A method for deriving the number of space-time streams corresponding to another channel width and beneficial effects thereof have been described in detail in the foregoing general description. Details are not described herein again.

Optionally, when the first channel width indication information and the second channel width indication information jointly indicate different channel widths, the first space-time stream number indication information and the second space-time stream number indication information jointly indicate a same number of space-time streams.

In other words, the third control subfield is used to indicate different channel widths and a same number of space-time streams. Beneficial effects of indicating the same number of space-time streams have been described in detail in the foregoing general description. Details are not described herein again.

In some embodiments, the channel width indication information or the space-time stream number indication information in the control subfield in the 802.11ax standard is carried in two indication subfields. This implements the enhanced OM negotiation while ensuring maximum compatibility with the 802.11ax standard.

In some embodiments, a technical solution of the enhanced OM negotiation in which an OMI sent by the AP to the STA 1 is indicated by using one control subfield when the AP performs OM negotiation with the STA 1.

In some embodiments, the control subfield is referred to as a fourth control subfield. Correspondingly, the OMI is carried in control information corresponding to the fourth control subfield. The control information includes at least either of fourth channel width indication information and fourth space-time stream number indication information.

Optionally, the fourth channel width indication information is 2 bits, and indicates a channel width range from 20 MHz to 320 MHz.

As shown in Table 7:

TABLE 7
Recharacterized enhanced channel width indication - manner 1

| Channel | | Description in a case in |
|---|---|---|
| width in | Description in a case in | which at least either of |
| an OMI | which both the transmitter | the transmitter and the |
| control | and the receiver support | receiver does not support |
| subfield | the 11 be standard | the 11 be standard |
| 00 | 20 MHz | 20 MHz |
| 01 | 80 MHz | 40 MHz |
| 10 | 160 MHz or 80 + 80 MHz | 80 MHz |
| 11 | 320 MHz or 160 + 160 MHz | 160 MHz or 80 + 80 MHz |

Both the initiator and the responder support a standard after the 802.11ax, and a channel width range indicated by the fourth channel width indication information in the fourth control subfield (the OMI control subfield) is 20 MHz to 320 MHz.

Alternatively, either of the initiator and the responder does not support a standard after the 802.11ax, and a channel width range indicated by the fourth channel width indication information is 20 MHz to 160 MHz.

For example, the fourth channel width indication information is indicated to be 2 bits, and a value of the 2 bits is 11. In one case, both the initiator and the responder support a standard after the 802.11ax, for example, the 802.11be standard. Then 11 means that a channel width negotiated by the initiator and the responder is 320 MHz or 160+160 MHz. In another case, either of the initiator and the responder does not support a standard after the 802.11ax. For example, the responder does not support the 802.11be standard. Then 11 means that a channel width negotiated by the initiator and the responder is 160 MHz or 80+80 MHz.

In another possible implementation, the fourth channel width indication information indicates any one of the following four types:

a channel width of 20 MHz, a channel width of 40 MHz, a channel width of 80 MHz, and supported within a capability range.

As shown in Table 8:

TABLE 8
Recharacterized enhanced channel width indication - manner 2

| Channel | | Description in a case in |
|---|---|---|
| width in | Description in a case in | which at least either of |
| an OMI | which both the transmitter | the transmitter and the |
| control | and the receiver support | receiver does not support |
| subfield | the 11 be standard | the 11 be standard |
| 00 | 20 MHz | 20 MHz |
| 01 | 40 MHz | 40 MHz |
| 10 | 80 MHz | 80 MHz |
| 11 | Supported within a | 160 MHz or 80 + 80 MHz |
| | capability range | |

As shown in FIG. 8, the fourth channel width indication information is 2 bits, and a value of the 2 bits is 11. In one case, both the initiator and the responder support a standard after the 802.11ax, for example, the 802.11be standard. Then 11 means that a channel width negotiated by the initiator and the responder is supported within a capability range. In another case, either of the initiator and the responder does not support a standard after the 802.11ax. For example, the responder does not support the 802.11be standard. Then 11 means that a channel width negotiated by the initiator and the responder is 160 MHz or 80+80 MHz.

In some embodiments, Table 7 and Table 8 are examples. A channel width indicated by the 2-bit fourth channel width indication information further is another value, for example, 240 MHz, 160+80 MHz, or 80+160 MHz. However, the following condition is satisfied: Both the initiator and the responder support a standard after the 802.11ax, then the 2-bit indicates any four values from 20 MHz to 320 MHz; or either of the initiator and the responder does not support a standard after the 802.11ax, then the 2-bit indicates any four values from 20 MHz to 160 MHz.

In some embodiments, the fourth channel width indication information indicates a greater channel width range, for example, indicate 640 MHz.

Similarly, in the control information corresponding to the fourth control subfield, the fourth space-time stream number indication information is 3 bits, and indicates that a range of the number of space-time streams is 1 to 16.

In an implementation, both the initiator and the responder support a standard after the 802.11ax, and the number of space-time streams indicated by the fourth space-time stream number indication information is any value from 1 to 16. Optionally, the fourth space-time stream number indication information indicates any eight values from 1 to 16.

Alternatively, either of the initiator and the responder does not support a standard after the 802.11ax, and the number of space-time streams indicated by the fourth space-time stream number indication information is any value from 1 to 8.

As shown in Table 9:

TABLE 9
Recharacterized enhanced Tx NSTS indication
or enhanced Rx NSS indication - manner 1

| | | Description in a case in |
|---|---|---|
| | Description in a case in | which at least either of |
| | which both the transmitter | the transmitter and the |
| Tx NSTS/Rx | and the receiver support | receiver does not support |
| NSS in the | the 11be standard | the 11be standard |
| OM control | (supported Tx NSTS or | (supported Tx NSTS or |
| subfield | Rx NSS) | Rx NSS) |
| 000 | 1 | 1 |
| 001 | 2 | 2 |
| 010 | 4 | 3 |
| 011 | 6 | 4 |
| 100 | 8 | 5 |
| 101 | 10 | 6 |
| 110 | 12 | 7 |
| 111 | 16 | 8 |

In the OMI control subfield, if the number of bits used to indicate Tx NSTS/Rx NSS remains unchanged at 3 bits, a mode supported by 11ax (for example, modes 3, 5, or 7 of Tx NSTS/Rx NSS) is replaced with a new mode that needs to be supported (modes 10, 12, or 16 of Tx NSTS/Rx NSS in Table 9). A description column to be used is determined by the receiver (the responder for the OM negotiation) of the OM control subfield based on whether the receiver supports the 802.11be standard (or a subsequent standard).

In another implementation, a greater channel width or a greater number of space-time streams is not distinguished. Therefore, a preset value is used to represent that OMs are supported within a capability range. As shown in Table 10:

TABLE 10
Recharacterized enhanced Tx NSTS indication
or enhanced Rx NSS indication - manner 2

| | | Description in a case in |
|---|---|---|
| | Description in a case in | which at least either of |
| | which both the transmitter | the transmitter and the |
| Tx NSTS/Rx | and the receiver support | receiver does not support |
| NSS in the | the 11be standard | the 11be standard |
| OM control | (supported Tx NSTS or | (supported Tx NSTS or |
| subfield | Rx NSS) | Rx NSS) |
| 000 | 1 | 1 |
| 001 | 2 | 2 |
| 010 | 3 | 3 |
| 011 | 4 | 4 |
| 100 | 5 | 5 |
| 101 | 6 | 6 |
| 110 | 7 | 7 |
| 111 | Supported within a | 8 |
| | capability range | |

In the examples shown in Table 9 and Table 10, if the receiver (the responder for the OM negotiation) of the OM control subfield does not support the 802.11be standard, the receiver needs to send corresponding information based on original description of the OM subfield characterized in the 11ax, instead of new description.

Similarly, one STA that supports the 11ax standard does not know how to interpret based on the new description, and interprets based on the description in the 11ax.

For example, if the responder for the OM negotiation is a STA that supports the 802.11ax standard, the responder does not know whether the responder supports the 11be, and does not determine whether the initiator for the OM negotiation supports the 11be. The STA parses the OMI in a manner specified in the 802.11ax standard. In this case, if the initiator for the OM negotiation supports a standard after the 802.11ax standard, for example, the 802.11be standard, the initiator is unable to send the enhanced OM indication information provided in some embodiments to the STA.

If the responder for the OM negotiation is a STA that supports a standard after the 802.11ax standard, for example, the responder knows that the responder is a STA that supports the 802.11be, when receiving the OMI, the responder needs to determine whether the initiator supports a standard after the 802.11ax standard (the responder learns, through a transmitter address, of a standard type supported by the initiator) to acknowledge by default, that the initiator definitely supports the standard after the 802.11ax standard. In this case, the OMI sent by the initiator is an enhanced OMI.

In some embodiments, the fourth space-time stream number indication information indicates a greater range of the number of space-time streams, for example, 1 to 32, or 1 to 64. When the existing number of bits remains unchanged, 3 bits are used to indicate any eight values from 1 to 32, or any eight values from 1 to 64, or seven values thereof plus “those supported within a capability range”.

In an implementation, the number of space-time streams indicated by the fourth space-time stream number indication information is less than or equal to the number of space-time streams of a preset channel width value. The preset channel width value is 80 MHz or 160 MHz.

In an implementation, when the fourth channel width indication information indicates different channel widths, the fourth space-time stream number indication information indicate a same number of space-time streams.

In some embodiments, without increasing the number of bits of an existing control subfield, based on whether a standard after the 802.11ax is supported, same OMI information is parsed into different description. Therefore, the enhanced OM negotiation is implemented while ensuring the maximum compatibility with the 802.11ax standard at minimum overheads.

Without loss of generality, a sequence of control sub-information in the control information corresponding to a control subfield in some embodiments is an example. There is another variation. the number of bits of another control sub-information further is adaptively changed. This is not limited.

In some embodiments, the enhanced OM negotiation method provided is described with the AP serving as the initiator for the OM negotiation and the STA 1 serving as the responder for the OM negotiation.

The STA serves as the initiator for the OM negotiation, and the AP serves as the responder for the OM negotiation. OM negotiation between APs or STAs is similar. Details are not described herein.

To implement the technical solution of the enhanced OM negotiation provided in some embodiments, the access point and the station includes a hardware structure and a software module, and implement the functions in a form of the hardware structure, the software module, or a combination of the hardware structure and the software module. A function in the foregoing functions are implemented in a form of the hardware structure, the software module, or the combination of the hardware structure and the software module.

A person skilled in the art further understands that various illustrative logical blocks (illustrative logic block) and steps (step) that are listed in some embodiments are implemented by using electronic hardware, computer software, or a combination thereof. Whether the functions are implemented by using hardware or software depends on particular applications and a design of an entire system. A person skilled in the art is configured to use various methods to implement the described functions for each particular application, but consideration that the implementation goes beyond the scope of the embodiments is unrealistic.

In some embodiments, a computer-readable storage medium is provided. The computer-readable storage medium stores a computer program, and when the computer-readable storage medium is executed by a computer, a function of any one of the foregoing method embodiments is implemented.

In some embodiments, a computer program product is provided. When the computer program product is executed by a computer, functions of any one of the foregoing method embodiments are implemented.

All or some of the foregoing embodiments are implemented by using software, hardware, firmware, or any combination thereof. When software is used to implement the embodiments, all or some of the embodiments are implemented in a form of a computer program product. The computer program product includes one or more computer instructions. When the computer instructions are loaded or executed on the computer, the procedures or functions according to some embodiments are all or partially generated. The computer is a general-purpose computer, a dedicated computer, a computer network, or another programmable apparatus. The computer instructions are stored in a computer-readable storage medium or are transmitted from a computer-readable storage medium to another computer-readable storage medium. For example, the computer instructions are transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium is any usable medium accessible by the computer, or a data storage device, such as a server or a data center, integrating one or more usable media. The usable medium is a magnetic medium (for example, a floppy disk, a hard disk drive, or a magnetic tape), an optical medium (for example, a high-density digital video disc (digital video disc, DVD)), a semiconductor medium (for example, a solid-state disk (solid state disk, SSD)), or the like.

A person of ordinary skill in the art understands that various numerals such as “first” and “second” in the embodiments are used for differentiation for ease of description, and are not used to limit the scope of the embodiments or represent a sequence.

The correspondences shown in the tables in some embodiments are configured, or are predefined. Values of the information in the tables are examples, and other values are configured. This is not limited. When a correspondence between configuration information and each parameter is configured, the configuration of each correspondence shown in the tables is optional. For example, in the tables, correspondences shown in some rows alternatively is unable to be configured. For another example, proper deformations and adjustments such as splitting and combination is performed based on the foregoing tables. Names of the parameters shown in titles of the foregoing tables alternatively is other names that is understood by a communications apparatus, and values or representation manners of the parameters alternatively is other values or representation manners that is understood by the communications apparatus. During implementation of the foregoing tables, another data structure, such as an array, a queue, a container, a stack, a linear table, a pointer, a linked list, a tree, a graph, a structure, a class, a pile, or a hash table, alternatively is used.

“Predefine” in the embodiments is understood as “characterize”, “predetermine”, “store”, “pre-store”, “pre-negotiate”, “pre-configure”, “solidify”, or “pre-burn”.

A person skilled in the art is aware that units and algorithm steps in the examples described with reference to the embodiments disclosed in this specification is implemented by electronic hardware or a combination of computer software and electronic hardware. Whether the functions are performed by hardware or software depends on particular applications and design constraints of the technical solutions. A person skilled in the art is configured to use different methods to implement the described functions for each particular application, but implementation beyond the scope of the embodiments is unconsidered.

A person skilled in the art that, for the purpose of convenient and brief description, for a detailed working process of the foregoing system, apparatus, and unit, refer to a corresponding process in the foregoing method embodiments, and details are not described herein again.

The foregoing descriptions are implementations of the embodiments, but are not intended to limit the protection scope of the embodiments. Any variation or replacement readily figured out by a person skilled in the art within the technical scope disclosed in the embodiments shall fall within the protection scope of the embodiments. Therefore, the protection scope shall be subject to the claims.

1. A negotiation method for an operating mode comprising:
sending, by an initiator for operating mode negotiation, an operating mode indication (OMI) to a responder, wherein:
the OMI includes at least either of channel width indication information and space-time stream number indication information;
a capability range of a channel width indicated by the channel width indication information is greater than 160 MHz; and
a capability range of a number of space-time streams indicated by the space-time stream number indication information is greater than 8; and
performing, by the initiator, transmission with the responder.

2. The method according to claim 1, further comprising:
before sending the OMI to the responder, carrying the OMI in control information corresponding to a control subfield, and the control information includes at least either of the channel width indication information and the space-time stream number indication information.

3. The method according to claim 2, wherein:
the control subfield includes a first control subfield and a second control subfield;
the first control subfield is an OMI basic indication subfield;
the second control subfield is an OMI extension indication subfield; and
the first control subfield and the second control subfield jointly indicate an enhanced OMI.

4. The method according to claim 3, wherein:
a number of bits of first channel width indication information that is in control information corresponding to the first control subfield and that indicates the channel width is 2;
a number of bits of second channel width indication information that is in control information corresponding to the second control subfield and that indicates the channel width is 1; and
a channel width range jointly indicated by the first channel width indication information and the second channel width indication information is 20 MHz to 320 MHz.

5. The method according to claim 4, wherein:
a number of bits of first space-time stream number indication information that is in the control information corresponding to the first control subfield and that indicates the number of space-time streams is 3;
a number of bits of second space-time stream number indication information that is in the control information corresponding to the second control subfield and that indicates the number of space-time streams is 1 and
a range of a number of space-time streams jointly indicated by the first space-time stream number indication information and the second space-time stream number indication information is 1 to 16.

6. The method according to claim 5, wherein:
the number of space-time streams jointly indicated by the first space-time stream number indication information and the second space-time stream number indication information is less than or equal to a number of space-time streams of a preset channel width value.

7. A communications apparatus, serving as an initiator for operating mode OM negotiation, comprise:
a transceiver, configured to send an operating mode indication (OMI) to a responder, wherein:
the OMI includes at least either of channel width indication information and space-time stream number indication information;
a capability range of a channel width indicated by the channel width indication information is greater than 160 MHz; and
a capability range of a number of space-time streams indicated by the space-time stream number indication information is greater than 8; and
a processor, configured to perform transmission with the responder.

8. The apparatus according to claim 7, wherein:
the OMI is carried in control information corresponding to a control subfield, and the control information includes at least either of the channel width indication information and the space-time stream number indication information.

9. The apparatus according to claim 8, wherein:
the control subfield includes a first control subfield and a second control subfield;
the first control subfield is an OMI basic indication subfield;
the second control subfield is an OMI extension indication subfield; and
the first control subfield and the second control subfield jointly indicate an enhanced OMI.

10. The apparatus according to claim 9, wherein:
a number of bits of first channel width indication information that is in control information corresponding to the first control subfield and that indicates the channel width is 2;
a number of bits of second channel width indication information that is in control information corresponding to the second control subfield and that indicates the channel width is 1; and
a channel width range jointly indicated by the first channel width indication information and the second channel width indication information is 20 MHz to 320 MHz.

11. The apparatus according to claim 9, wherein:
a number of bits of first space-time stream number indication information that is in the control information corresponding to the first control subfield and that indicates the number of space-time streams is 3;
a number of bits of second space-time stream number indication information that is in the control information corresponding to the second control subfield and that indicates the number of space-time streams is 1; and
a range of a number of space-time streams jointly indicated by the first space-time stream number indication information and the second space-time stream number indication information is 1 to 16.

12. The apparatus according to claim 11, wherein:
the number of space-time streams jointly indicated by the first space-time stream number indication information and the second space-time stream number indication information is less than or equal to a number of space-time streams of a preset channel width value.

13. A negotiation method for an operating mode comprising:
receiving, by a responder for operating mode negotiation, an operating mode indication (OMI) from an initiator, wherein:
the OMI includes at least either of channel width indication information and space-time stream number indication information;
a capability range of a channel width indicated by the channel width indication information is greater than 160 MHz; and
a capability range of a number of space-time streams indicated by the space-time stream number indication information is greater than 8; and
performing transmission with the initiator based on the OMI.

14. The method according to claim 13, wherein:
the OMI is carried in control information corresponding to a control subfield, and the control information includes at least either of the channel width indication information and the space-time stream number indication information.

15. The method according to claim 14, wherein:
the control subfield includes a first control subfield and a second control subfield; and
the first control subfield is an OMI basic indication subfield;
the second control subfield is an OMI extension indication subfield; and
the first control subfield and the second control subfield jointly indicate an enhanced OMI.

16. The method according to claim 15, further comprising:
jointly parsing, by the responder, first channel width indication information in the first control subfield and second channel width indication information in the second control subfield, to obtain an indicated channel width.

17. A communications apparatus, comprises:
a transceiver, configured to receive an operating mode indication (OMI) from an initiator, wherein:
the OMI includes at least either of channel width indication information and space-time stream number indication information;
a capability range of a channel width indicated by the channel width indication information is greater than 160 MHz; and
a capability range of a number of space-time streams indicated by the space-time stream number indication information is greater than 8; and
a processor, configured to perform transmission with the initiator based on the OMI.

18. The apparatus according to claim 17, wherein:
the OMI is carried in control information corresponding to a control subfield, and the control information includes at least either of the channel width indication information and the space-time stream number indication information.

19. The apparatus according to claim 18, wherein:
the control subfield includes a first control subfield and a second control subfield;
the first control subfield is an OMI basic indication subfield;
the second control subfield is an OMI extension indication subfield; and
the first control subfield and the second control subfield jointly indicate an enhanced OMI.

20. The apparatus according to claim 19, further comprising:
a responder that jointly parses first channel width indication information in the first control subfield and second channel width indication information in the second control subfield, to obtain an indicated channel width.
